(19) United States
(12) Patent Application Publication
(10) Pub. No.: US 2024/0325998 A1
(43) Pub. Date: Oct. 3, 2024

(54) VERIFICATION OF SOLID DISSOLUTION IN ROBOTIC PHARMACEUTICAL PREPARATION

(71) Applicant: Equashield Medical Ltd, Migdal Tefen (IL)

(72) Inventors: Eric SHEM-TOV, Ramat Hasharon (IL); Osnat PERRY, Harduf (IL); Jenia GERSHTEIN, Karmiel (IL)

(21) Appl. No.: 18/620,584

(22) Filed: Mar. 28, 2024

Related U.S. Application Data
(60) Provisional application No. 63/455,117, filed on Mar. 28, 2023.

(51) Int. Cl. B01F 35/22; B01F 23/50; B01F 35/213; B01F 35/222; B01F 101/22

(52) U.S. Cl. CPC B01F 35/2202; B01F 23/51; B01F 23/59; B01F 35/213; B01F 35/2209; B01F 35/222; B01F 2101/22

(57) ABSTRACT

Image-based verification of progress and/or results, and or detection of fault conditions, for automated operations preparing pharmaceuticals, particularly in relation to the dissolving of pharmaceutical materials contained in vials. Imaging is and image processing is used, in some examples, to follow the progress of processing which converts solid and/or concentrated material (e.g., crystallized and/or lyophilized) into fluid solutions and/or suspensions. As conditions vary, time to dilute may change; detection of fault conditions may reduce risk and/or reduce waste. In some examples, a quantity of fluid used in dissolution/dilution is itself monitored at one or more stages. Methods of assessing fluid contents of vials, including vials distributed for use in manual operations which may include obstructions to viewing such as labels.

### RELATED APPLICATIONS

This application claims the benefit of priority of U.S. Provisional Patent Application No. 63/455,117 filed on Mar. 28, 2023, the contents of which are incorporated herein by reference in their entirety.

### FIELD AND BACKGROUND OF THE INVENTION

The present invention, in some embodiments thereof, relates to the field of devices for robotic preparation of pharmaceuticals, and more particularly, but not exclusively, to mixing of substances by such devices.

Problems of implementation of automation of pharmaceutical preparation have been recognized in the conventional art and various techniques have been developed to provide solutions.

### SUMMARY OF THE INVENTION

According to an aspect of some examples of the present disclosure, there is provided a method of assessing contents of a vial, the contents including a pharmaceutical ingredient, wherein the method includes: manipulating the vial to change a tilt angle of the vial relative to a boundary region of the contents of the vial; obtaining at least one image of the vial during a period in which the tilt angle is changed; by image processing with processing circuitry, calculating a position of the boundary region in the at least one image; comparing the position of the boundary region to a target criterion, wherein the target criterion accounts for a shift in the position of the boundary region due to the tilt angle; and according to a result of the comparing, automatically determining use or rejection of the contents of the vial in automated preparation of a pharmaceutical preparation.

According to some examples of the present disclosure, the manipulating changes the tilt angle so that the boundary region in the at least one image of the vial extends along a bottom surface of the vial.

According to some examples of the present disclosure, the target criterion includes a target position extending along the bottom surface, and the comparing determines a location of the boundary region relative to the target position.

According to some examples of the present disclosure, a label obstructs viewing of the contents through a viewing-obstructed side region of the vial, and the change in tilt angle moves the boundary region from the viewing-obstructed side region to an unobstructed surface region of the vial through which the boundary region is visible.

According to some examples of the present disclosure, the target criterion includes a target position along the unobstructed surface region of the vial, and the comparing determines a location of the boundary region relative to the target position.

According to some examples of the present disclosure, the target position extends along a portion of the vial surface which is located above or below the label when the vial is upright.

According to some examples of the present disclosure, during the period in which the tilt angle is changed, height of the contents is a non-linear function of contents volume.

According to some examples of the present disclosure, the manipulating includes rotation of the vial while the boundary region remains horizontal.

According to some examples of the present disclosure, the manipulating includes movement of the vial which changes an angle of the boundary region away from horizontal.

According to some examples of the present disclosure, at least one of the comparing and the automatically determining includes calculating a volume of the contents of the vial, and the automatically determining selects use or rejection of the contents of the vial according to how closely the volume approximates a target volume.

According to some examples of the present disclosure, the target criterion defines a target position, a result of the comparing includes a distance between the position of the boundary region and the target position, and the determining selects use or rejection of the contents of the vial according to the distance.

According to some examples of the present disclosure, the boundary region indicates a difference in an optical property between a lower material phase of the contents of the vial and material above it.

According to some examples of the present disclosure, the optical property is at least one of index of refraction, optical absorption coefficient, and turbidity.

According to some examples of the present disclosure, the at least one image includes a plurality of images obtained at different tilt angles of the vial.

According to some examples of the present disclosure, the calculating and comparing are performed for each of the plurality of images.

According to some examples of the present disclosure, the automatically determining includes determining a parameter of geometry of the vial, using the position characterizations for each of the plurality of images.

According to some examples of the present disclosure, at least one image is obtained while the tilt angle is changed by at least 45° from an upright and stationary position of the vial.

According to some examples of the present disclosure, at least one image is obtained while the vial is tilted to within 15° of horizontal.

According to some examples of the present disclosure, the contents of the vial comprise a fluid.

According to some examples of the present disclosure, the vial includes a generally cylindrical lower region, an inward curving top region leading to a capped neck, and a round bottom surface of the lower region; wherein the tilt angle adjusts a portion of the boundary region so that it extends along the bottom surface.

According to some examples of the present disclosure, the at least one image images the boundary region through optical irregularities of the bottom surface.

According to some examples of the present disclosure, the determining use of the contents of the vial includes determining adjustments to a quantity of fluid in the vial to correct for a difference between the target position and the position characterization of the boundary region.

According to some examples of the present disclosure, the method includes manipulating the vial to a new position, according to the determined use.

According to some examples of the present disclosure, the new position returns the vial to an upright position.

According to an aspect of some examples of the present disclosure, there is provided a method of assessing fluid contents of a vial including a pharmaceutical ingredient, the method including: receiving at least one image of the vial, wherein the at least one image is of the vial while tilted to position a portion of a boundary layer of the fluid contents below a labeled portion of the vial surface; using computerized image processing, comparing a position of the boundary layer extending along a bottom surface of the vial with a target position corresponding to a targeted amount of fluid in the vial, and to a tilt angle of the vial; and according to a result of the comparing, automatically determining use or rejection of the contents of the vial in automated preparation of a pharmaceutical preparation.

According to some examples of the present disclosure, the fluid contents comprise a solvent in which the pharmaceutical ingredient is dissolved.

According to some examples of the present disclosure, the comparing includes determining a liquid volume of the contents, and comparing the determined volume to a targeted liquid volume of the contents.

According to some examples of the present disclosure, the determining a volume includes measuring at least one parameter of a geometry of the vial, using the at least one image of the vial.

According to an aspect of some examples of the present disclosure, there is provided a method of assessing contents of a vial, the contents including a pharmaceutical ingredient, wherein the method includes: manipulating the vial to change a tilt angle of the vial; obtaining at least one image of the vial during a period in which the tilt angle is changed; by image processing with processing circuitry, detecting presence or absence of a fluid boundary region in the at least one image; and according to a result of the detecting, automatically determining use or rejection of the contents of the vial in automated preparation of a pharmaceutical preparation.

According to some examples of the present disclosure, the tilt angle is selected to position the fluid boundary region to extend along a surface region of the the vial located above or below a label of the vial when the vial is upright, when the contents of the vial include a targeted volume of fluid.

According to some examples of the present disclosure, the surface region is below the label of the vial, and extends along a bottom surface of the vial.

According to an aspect of some examples of the present disclosure, there is provided a system for assessing vial contents including a pharmaceutical ingredient, the system including: processing circuitry and memory, wherein the memory includes instructions which instruct the processing circuitry to: control a manipulator to change a tilt angle of the vial relative to an upper boundary layer of the vial contents; access at least one image of the vial obtained during a period in which the tilt angle is changed; calculate a position characterization of a boundary region of the vial contents in the at least one image; compare the position characterization of the boundary region to a target position, wherein the target position accounts for boundary region shift due to the tilt angle; and according to a result of the comparing, instruct the system to use or reject the vial contents in automated preparation of a pharmaceutical preparation.

According to some examples of the present disclosure, the system includes the manipulator.

According to some examples of the present disclosure, the instructions instruct the processing circuitry to control the imager to obtain the at least one image of the vial.

According to an aspect of some examples of the present disclosure, there is provided a system for assessing vial contents including a pharmaceutical ingredient, the system including: a manipulator, configured to hold the vial with a variably selectable tilt angle relative to an upright orientation of the vial; an imager, positioned with respect to the manipulator for imaging the vial while held at tilt angles relative to the upright orientation, including viewing of a bottom surface of the vial; processing circuitry and a memory storing instructions, wherein the instructions instruct the processing circuitry to: control the manipulator to change the tilt angle of the vial relative to the upright orientation; control the imager to obtain the at least one image of the vial during a period in which the tilt angle is changed; calculate a position characterization of a boundary region of the vial contents in the at least one image; compare the position characterization of the boundary region to a target position, wherein the target position accounts for boundary region shift due to the tilt angle; and according to a result of the comparing, instruct the system to use or reject the vial contents in automated preparation of a pharmaceutical preparation.

According to an aspect of some examples of the present disclosure, there is provided a method of controlling dissolution of a solute into a solvent in a vial, the vial being held by a vial holder in a pharmaceutical preparation device, the method including: agitating the vial holder by an agitator operably connected to the vial holder, thereby shaking the solute and the solvent in the vial being held by the vial holder; accessing, by processing circuitry, at least one image of vial contents captured after the agitation was initiated; by image processing with the processing circuitry, assessing a characteristic of vial contents; comparing the assessed characteristic to a targeted characteristic of the vial contents; and adjusting, by the processing circuitry, agitation by the agitator, in accordance with a result of the comparing.

According to some examples of the present disclosure, the adjusting includes halting agitation.

According to some examples of the present disclosure, the adjusting includes restarting agitation.

According to some examples of the present disclosure, the adjusting includes modifying at least one parameter of agitation motion.

According to some examples of the present disclosure, the solute is a solid.

According to some examples of the present disclosure, the solvent is a fluid.

According to some examples of the present disclosure, the assessed characteristic assesses dissolution of the solute into the solvent, the targeted characteristic of the vial contents includes a dissolution appearance criterion, and the adjusting includes halting or extending a period of operation of the agitator.

According to some examples of the present disclosure, the adjusting includes halting operation of the agitator while the targeted dissolution appearance criterion remains unsatisfied; and raising an alert.

According to some examples of the present disclosure, the adjusting includes extending operation of the agitator while the targeted dissolution appearance criterion remains unsatisfied.

According to some examples of the present disclosure, the dissolution appearance criterion includes a measure of at least one of: transparency of the solvent, color of the solvent, and clarity of the solvent.

According to some examples of the present disclosure, the dissolution appearance criterion includes the measure of color of the solvent, selected in accordance with a type of the solute.

According to some examples of the present disclosure, the assessed characteristic assesses caking of the solute, the targeted characteristic of the solvent in the vial includes a caking appearance criterion, and the adjusting includes modifying a parameter governing a movement pattern of the agitator.

According to some examples of the present disclosure, the movement pattern is adjusted in at least one of: an amplitude, an acceleration, a rotation of the vial, and a geometry of a path along which the vial is moved.

According to some examples of the present disclosure, the assessed characteristic assesses presence of foreign particles in the solvent, the targeted characteristic of the vial contents includes a foreign particle presence criterion, and the adjusting includes halting agitation; and also in accordance with the result of the comparing, the processing circuitry raises an alert.

According to some examples of the present disclosure, the assessed characteristic assesses presence of foreign particles in the solvent, the targeted characteristic of the vial contents includes a foreign particle presence criterion, and the adjusting includes halting agitation; and also in accordance with the result of the comparing, the processing circuitry raises an alert.

According to some examples of the present disclosure, the assessed characteristic assesses a volume of the vial contents, the targeted characteristic of the solvent in the vial includes an expected amount of the vial contents, and the adjusting includes halting agitation; and also in accordance with the result of the comparing, the processing circuitry raises an alert.

According to some examples of the present disclosure, at least one of the assessing the characteristic and the comparing includes classifying the at least one image in accordance with a pre-trained machine learning model.

According to some examples of the present disclosure, the adjusting includes adjusting agitation of an at least second vial, according to the result of the comparing.

According to some examples of the present disclosure, the adjusting is according to a plurality of the results of a respective plurality of the comparings.

According to some examples of the present disclosure, the at least one image of vial contents is imaged from a position below the vial.

According to an aspect of some examples of the present disclosure, there is provided a system for controlling dissolution of a solute into a solvent in a vial, the vial being held by a vial holder in a pharmaceutical preparation device, the system including processing circuitry configured to: control an agitator operably connected to the vial holder, thereby shaking the solute and the solvent in the vial being held by the vial holder; access at least one image of vial contents captured after the agitation was initiated; assess a characteristic of the vial contents; compare the assessed characteristic to a targeted characteristic of the solvent in the vial; and adjust agitation of the agitator in accordance with a result of the comparing.

According to some examples of the present disclosure, the assessed characteristic assesses dissolution of the solute into the solvent, the targeted characteristic of the solvent in the vial includes a dissolution appearance criterion, and the processing circuitry adjusts agitation by halting or extending a period of operation of the agitator.

According to some examples of the present disclosure, the assessed characteristic assesses caking of the solute, the targeted characteristic of the solvent in the vial includes a caking appearance criterion, and the processing circuitry adjusts agitation by modifying a parameter governing a movement pattern of the agitator.

According to some examples of the present disclosure, the assessed characteristic assesses presence of foreign particles in the solvent, the targeted characteristic of the solvent in the vial includes a foreign particle presence criterion, and the processing circuitry adjusts agitation by halting agitation; and also in accordance with the result of the comparing, the processing circuitry raises an alert.

According to some examples of the present disclosure, the assessed characteristic assesses presence of foreign particles in the solvent, the targeted characteristic of the solvent in the vial includes a foreign particle presence criterion, and the processing circuitry adjusts agitation by halting agitation; and also in accordance with the result of the comparing, the processing circuitry raises an alert.

According to some examples of the present disclosure, the assessed characteristic assesses a volume of solvent in the vial, the targeted characteristic of the solvent in the vial includes an expected amount of solvent in the vial, and the processing circuitry adjusts agitation by halting agitation; and also in accordance with the result of the comparing, the processing circuitry raises an alert.

Unless otherwise defined, all technical and/or scientific terms used herein have the same meaning as commonly understood by one of ordinary skill in the art to which the present disclosure pertains. Although methods and materials similar or equivalent to those described herein can be used in the practice or testing of embodiments of the present disclosure, exemplary methods and/or materials are described below. In case of conflict, the patent specification, including definitions, controls. In addition, the materials, methods, and examples are illustrative only and are not intended to be necessarily limiting.

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, microcode, etc.) or an embodiment combining software and hardware aspects that may all generally be referred to herein as a “circuit,” “module” or “system” (e.g., a method may be implemented using “computer circuitry”). Furthermore, some embodiments of the present disclosure may take the form of a computer program product embodied in one or more computer readable medium(s) having computer readable program code embodied thereon. Implementation of the method and/or system of some embodiments of the present disclosure can involve performing and/or completing selected tasks manually, automatically, or a combination thereof. Moreover, according to actual instrumentation and equipment of some embodiments of the method and/or system of the present disclosure, several selected tasks could be implemented by hardware, by software or by firmware and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computer using any suitable operating system. In some embodiments of the present disclosure, one or more tasks performed in method and/or by system are performed by a data processor (also referred to herein as a “digital processor”, in reference to data processors which operate using groups of digital bits), such as a computing platform for executing a plurality of instructions. Instruction executing elements of the processor may comprise, for example, one or more microprocessor chips, ASICs, and/or FPGAs. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well. Any of these implementations are referred to herein more generally as instances of computer circuitry.

Any combination of one or more computer readable medium(s) may be utilized for some embodiments of the present disclosure. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer readable storage medium may also contain or store information for use by such a program, for example, data structured in the way it is recorded by the computer readable storage medium so that a computer program can access it as, for example, one or more tables, lists, arrays, data trees, and/or another data structure. Herein a computer readable storage medium which records data in a form retrievable as groups of digital bits is also referred to as a digital memory. It should be understood that a computer readable storage medium, in some embodiments, is optionally also used as a computer writable storage medium, in the case of a computer readable storage medium which is not read-only in nature, and/or in a read-only state.

Herein, a data processor is said to be “configured” to perform data processing actions insofar as it is coupled to a computer readable medium to receive instructions and/or data therefrom, process them, and/or store processing results in the same or another computer readable medium. The processing performed (optionally on the data) is specified by the instructions, with the effect that the processor operates according to the instructions. The act of processing may be referred to additionally or alternatively by one or more other terms; for example: comparing, estimating, determining, calculating, identifying, associating, storing, analyzing, selecting, and/or transforming. For example, in some embodiments, a digital processor receives instructions and data from a digital memory, processes the data according to the instructions, and/or stores processing results in the digital memory. In some embodiments, “providing” processing results comprises one or more of transmitting, storing and/or presenting processing results. Presenting optionally comprises showing on a display, indicating by sound, printing on a printout, or otherwise giving results in a form accessible to human sensory capabilities.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present disclosure may be written in any combination of one or more programming languages, including an object-oriented programming language such as Java, Smalltalk, C++ or the like and conventional procedural programming languages, such as the “C” programming language or similar programming languages. Additionally or alternatively, sequences of logical operations (optionally logical operations corresponding to computer instructions) may be embedded in the design of an ASIC and/or in the configuration of an FPGA device. The program code may execute entirely on the user's computer, partly on the user's computer (e.g., as a stand-alone software package), partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present disclosure may be described below with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer; and may not be feasible or practical for performing purely manually, by a human expert. A human expert who wanted to manually perform similar tasks, such inspecting objects, might be expected to use completely different methods, e.g., making use of expert knowledge and/or the pattern recognition capabilities of the human brain, which would be vastly more efficient than manually going through the steps of the methods described herein.

### BRIEF DESCRIPTION OF THE SEVERAL VIEWS OF THE DRAWINGS

Some embodiments of the present disclosure are herein described, by way of example only, with reference to the accompanying drawings. With specific reference now to the drawings in detail, it is stressed that the particulars shown are by way of example, and for purposes of illustrative discussion of embodiments of the present disclosure. In this regard, the description taken with the drawings makes apparent to those skilled in the art how embodiments of the present disclosure may be practiced.

In the drawings:

FIG. 1 schematically illustrates a block diagram of an example system 100 configured for controlled dissolution of a solid into a fluid, according to some examples of the presently disclosed subject matter;

FIGS. 2A-2F illustrate various methods of controlling dissolution of a solid into a liquid, according to some examples of the presently disclosed subject matter;

FIG. 3 illustrates a flow diagram of an example general method of monitoring and controlling a process of dissolution of a solid into a fluid, optionally as well as detecting and reporting faults, as part of a process of pharmaceutical preparation in a robotic pharmaceutical preparation system, according to some examples of the presently disclosed subject matter;

FIG. 4A is a photographic image of a vial (captured from beneath the vial) in which caking of the solid is present, in accordance with some examples of the presently disclosed subject matter;

FIG. 4B is a photographic image of a vial including foreign particles, in accordance with some examples of the present disclosure.

FIGS. 5A-5B are photographic images of a same vial with caked solid, in accordance with some examples of the presently disclosed subject matter;

FIG. 5C is a differential image obtained by subtracting the images of FIGS. 5A-5B from each other (in absolute value), in accordance with some examples of the presently disclosed subject matter;

FIGS. 6A-6B are photographic images of a vial including foreign particles, in accordance with some examples of the present disclosure;

FIG. 6C is an absolute value differential image constructed from the images of FIGS. 6A-6B, in accordance with some examples of the present disclosure;

FIG. 7 is a flowchart schematically representing a method of image-based inspection of a vial for determining its contained fluid quantity, in accordance with some examples of the presently disclosed subject matter;

FIG. 8 is a flowchart schematically representing a method of image-based inspection of a vial for determining the presence of fluid, in accordance with some examples of the presently disclosed subject matter;

FIG. 9A reproduces a photograph of a fluid-containing vial held by a gripper with a tilt angle of about a 90°, in accordance with some examples of the presently disclosed subject matter.

FIG. 9B reproduces a photograph of a solid-containing vial held by a gripper with a tilt angle of about a 90°, in accordance with some examples of the presently disclosed subject matter.

FIG. 9C reproduces a photograph of a fluid-containing vial held by a gripper with a tilt angle of about a 90°, in accordance with some examples of the presently disclosed subject matter.

FIGS. 10A-10B schematically represent a side-view cross section (FIG. 10A) and a bottom view (FIG. 10B) of a fluid-containing vial 115 with an oblique tilt angle α, in accordance with some examples of the presently disclosed subject matter.

FIG. 11 schematically represents side-view cross sections of a fluid-containing vial with a changing tilt angle α, in accordance with some examples of the presently disclosed subject matter.

FIGS. 12A-12B schematically represent a side-view cross section (FIG. 12A) and side view (FIG. 12B) of a labeled fluid-containing vial 115, in accordance with some examples of the presently disclosed subject matter;

FIG. 12C schematically represents a side-view cross section of a fluid-containing vial with an 90° tilt angle α, in accordance with some examples of the presently disclosed subject matter; and

FIG. 13 is a schematic diagram of vial geometry parameters, in accordance with some examples of the presently disclosed subject matter.

### DESCRIPTION OF SPECIFIC EMBODIMENTS OF THE INVENTION

The present invention, in some embodiments thereof, relates to the field of devices for robotic preparation of pharmaceuticals, and more particularly, but not exclusively, to mixing of substances by such devices.

### Overview

### Monitoring and Control of Pharmaceutical Substance Mixing

An aspect of some examples of the presently disclosed subject matter relates to the automatic monitoring and control of the mixing of pharmaceutical substances. In particular, dissolution of pharmaceutical substances into a solute is described. Monitoring and control of mixing to form of suspensions (e.g., emulsifications) is not excluded, changed as necessary and/or as may be indicated in relation to particular examples (for example, a criterion of uniform turbidity and/or opacity may be sought, in place of a criterion of transparency). In some examples, monitoring and control is implemented by a robotic pharmaceutical preparation system which operates to create pharmaceutical preparations by the measured transfer of fluids between a plurality of containers.

In some examples, for an initial or intermediate state of a container used in automated pharmaceutical preparation, the container comprises an as-yet undissolved solute and its intended solvent. For example, the solvent may be recently added to the solute (or the solute to the solvent), and/or a fraction of the solute may be precipitated from the solvent (e.g., precipitated during a period of cold storage). The solute may be either liquid or solid in form.

The amount of time and action required to dissolve the solute is potentially variable; e.g., depending on the chemical identities of the solute and/or solvent, the presence of other solutes in the solvent, the initial size of solute particles, and/or the temperature of the solute/solvent mixture, and/or other parameters. Moreover, different mixing actions potentially contribute differently to the rate of mixing, depending on the aspects of the contents such as solid contents which are caked compared too solid contents which easily reach suspension.

In some examples, a method of dissolution comprises first monitoring dissolution in one or more vials with a plurality of pauses in agitation to allow imaging which measures a state of dissolution of the solute into the solvent. Once an overall period sufficient for dissolution is determined, the method continues with mixing of one or more further vials omitting one or more of the pauses. In some embodiments, the first pause in the mixing of the one or more further vials is after a full period expected to result in the sufficient dissolution of the solute into the solvent.

In some examples, there is a concern for detecting and reacting to exception conditions (e.g., mitigating these conditions, and/or raising an alert). Examples of exception conditions include loss of fluid (e.g., due an insufficient seal and/or container damage), failure of a solid to dissolve as expected (e.g., to a completeness expected and/or within a time expected), and/or residual particles which do not meet the expected visual characteristics of the solid being dissolved (e.g., solid contaminants, for example, beads, glass shards, filter remnants, metal particles, or another foreign particle types).

### Indications and Measurements of Pharmaceutical Substance Mixing State

In some examples, an important indication of the progress and/or completion of mixing is the reduction and/or substantial disappearance of a solid phase material from a mixing vial, as the solute dissolves into its solvent. Reduction/disappearance of the solute is optionally monitored optically, e.g., using imaging of the vial and/or measurements of light interacting with the vial and its contents. Measurements (e.g., images and/or other measurements) optionally characterize the vial while in motion, and/or while at rest. Measurements of the vial at rest optionally comprise measurements of light interacting with the vial with its solute and/or solvent contents: fully dissolved in solute, mechanically mixed with solute but not yet fully dissolved (e.g., suspended), or fully or partially caked and/or settled out of solute.

Optionally (whether additionally or alternatively), non-optical measurements of mixing status are performed. For example, the measurements may use ultrasound as a source of radiant energy, with the measuring being in the form of an image, or another form of assessing interactions of the sound energy with the contents of the vial. In some examples, mixing status is assessed using another method, e.g., measurement of temperature changes which occur as a result of dissolving.

Optionally, assessment of mixing status comprises making a determination of solution turbidity. Depending on the measurement method, there is potentially a period during which a reduction in turbidity is not measurable. There may optionally be a period during which measurements are indicative of changes in turbidity (e.g., turbidity reduction).

For the case of a solute expected to completely dissolve in its solute, assessment of mixing status optionally comprises determining whether or not the contained contents have become fully clear. In some examples, there may be a shift in the absorption, transmission, and/or reflectance spectrum of the vial contents (e.g., a color change) as mixing progresses toward completion. Optical measurements optionally measure the spectrum shift. Optionally, the amount of spectrum shift is quantified as part of assessing the mixing status of vial contents.

Optionally, assessment of mixing status comprises making a determination that there is a remaining portion of undissolved solute, based on material that collects upon settling after agitation (e.g., after a pause period to allow such settling, e.g., a period of 1-10 seconds, 1-30 seconds, 1-60 seconds, or another period), and/or still remains unaffected (e.g., caked to vial surfaces) by agitation. In some examples, unmixed material may collect even during agitation, e.g., due to density separation within a vortex of the contents of the vial. Optionally, monitoring of mixing status comprises obtaining measurements of material in regions where such vortexes are expected to gather it.

In some examples, there may be a phase of mixing during which substantially clear fluid contents nevertheless include the presence of a small number of particles either not yet dissolved (e.g., large crystals of solute), or actually indissoluble (e.g., impurities or other inclusions). In some examples, measurements are performed to identify such particles; and to assess them according to their significance with respect to contents mixing status. For example, there may be a threshold of particle number and/or size, below which the vial contents are considered mixed, even if the particle number has not reached zero.

In some examples, images of vials which are themselves used in pharmaceutical preparation are used to help set system requirements. In some examples, a system operator approves results of system operations to mix a pharmaceutical preparation, e.g., approves a final result, and images taken during the mixing are optionally treated as representing valid results of intermediate pharmaceutical preparation operations. Additionally or alternatively, the system operator approves images or other measurements which directly indicate results of intermediate operations. For example, the system operator inspects an image of a boundary layer in a fluid vial and approves it as a standard for comparison. Additionally or alternatively, a system operator certifies that starting conditions are valid, and images of the vial are accepted as correlated indications of a valid quantity of fluid in the vial, based on the certification. The system operator may be, for example, a person directly providing instructions to the system, or a person who serves as an auxiliary monitor of system operation. In some examples, another automated system is provided in place of the system operator, e.g., an automated system specifically configured to validate pharmaceutical preparations according to suitable criteria of measured volume, composition, and/or other inputs.

In some embodiments, manipulations such as agitation of later vials are adjusted according to expectations set during the agitation of one or more initial vials. In particular, agitation of the one or more earlier vials may be monitored more closely (e.g., divided into more sub-periods between which agitation is paused to allow imaging), while agitation of the later vials is made more continuous, potentially relatively reducing their processing time.

### Factors Potentially Confounding Measurements

Moreover, in some examples, a condition potentially occurs in which a portion of solvent in a vial appears entirely clear, but elsewhere in the vial there remains one or more significant particles of solute. In such cases, a sampling window comprising only a portion of the vial contents may not be sufficient to determine the overall state vial contents mixing. Optionally, this scenario is mitigated and/or avoided by making measurements using images including substantially the whole contents of the vial.

The one or more significant particles may comprise solute which is “caked” (many smaller particles sticking, solvent-melted, sintered, or otherwise bound together). Caked solute may be attached to a surface of the vial so that it doesn't move relative to the vial during agitation, and/or it may be moving freely in the solvent. In some examples, caking is assessed by examining the shape of transparent portions of the vial to confirm that they include the vial's whole volumetric extent. In some examples, the presence of caked and/or other residual particles is assessed by looking for areas of contrasting measured light levels, and/or regions which undergo changes in measured light indicative of one or more particles moving through them.

Potentially, the vial contents have gaseous inclusions (bubbles and/or foam) which are pre-existing and/or generated by mixing agitation. In some examples, potentially confounding effects of such bubbles and/or foam on measurements are mitigated, e.g., by observation of bubble behavior (e.g., rising instead of sinking over a period of time, location of foam at an interface layer), and/or based on expectations of bubble formation and/or foaming, e.g., expectations calibrated for a particular solute-solvent system and/or mixing conditions.

It should be noted that different methods of mixing progress measurement are subject to different potential advantages and disadvantages. For example, measurements made during ongoing fluid agitation have a potential advantage in that they do not interrupt the mixing process to be performed, potentially allowing mixing to continue to completion sooner. Optionally, however, mixing movements are slowed momentarily and/or adjusted to present a suitable aspect of the vial to a camera or other imaging and/or measuring device. In some examples, assessment of mixing progress is made while fluid and/or solid contents of the vial remain in motion, e.g., while a vortex remains in the contents, and/or while contents are splashing inside the vial.

There are potential artifacts arising in images of such moving systems, e.g., motion blur may make particles obscure, while bubbles may be particularly difficult to distinguish from particles and/or more prevalent overall. In some examples, stroboscopic illumination may be used to partially mitigate, e.g., motion blur, while retaining potential advantages of allowing mixing motions to remain ongoing. Conversely, measurements made of solutions after agitation has stopped are potentially suitable to collect information about remaining solute particles as the concentrates by settling, and/or slow down in their movement so that they can be better tracked and assessed.

In some examples, a regime of measurements is selected such that measurement methods conducive to uninterrupted mixing (but potentially prone to confounding influences) are used during an earlier part of the mixing process. Determinations estimating mixing progress are then optionally used to select a time at which a different (e.g., confirming and/or potentially more reliable) measuring method should be used.

### Dynamic System Responses to Mixing Progress

Actions of the mixing sub-system itself and/or of the robotic pharmaceutical preparation system overall are optionally adjusted in response to measurements indicative of any of the states.

In some examples, estimated time to completion of mixing is calculated based on measurements of mixing progress during an initial phase of mixing. This estimated time to completion is optionally used as a basis for selecting a further action, either involving the vial and/or mixing subsystem itself, and/or another element of the overall functioning of the pharmaceutical preparation system.

For example, recalcitrant caking is optionally identified early in the mixing process, allowing the vial to be exchanged for a new vial with relative efficiency and minimization of lost time (optionally the vial is returned to use after a period of “pre-soaking”, or another mitigation action). In some examples, estimated time to completion of mixing is used to estimate a value (in terms of saved time) of a period of especially vigorous shaking which may nonetheless lead to foaming and/or bubble formation which produces an additional period of waiting for settling. In some examples rates of bubble formation and/or bubble dissipation are tracked along with substance mixing in order to arrive at appropriately energetic mixing regimes which do not entail more post-mixing settling time than was saved by speeding the rate of mixing itself. In some examples, a period of delay for transport or other preparation after the end of active mixing agitation is relied on as a period for completing mixing, e.g., a period allowing final remaining crystals of a solute to dissolve. In some examples, measurements of the rate of mixing are used to calculate how much final mixing can be expected to occur during an anticipated period of such delay.

In another example, coordination with activities further along in the pharmaceutical preparation process is optionally adjusted to account for an expected time at which mixing will complete. For example, a time of removal of a reagent from refrigeration and/or radioactive shielding is optionally adjusted so that the reagent reaches a state and/or position to interact with the mixed contents of the vial just as they will be ready for it.

In some examples, the progress of mixing is tracked over time and related to aspects of actions and/or events which may have occurred during previous processing of the vial. For example, parameters of positioning and movement accompanying an earlier injection of solvent into a vial of dried solute are optionally varied according to results indicating which methods of injection appear most effective at leading to rapid mixing. Examples of this include adjusting relative depth of injecting cannula penetration to the vial, and or relative re-orientation of vial and cannula to direct fluid jets to walls and/or corners of the vial. Optionally, at least partially arbitrary variation in these parameters is performed as a matter of course during device operations, with successful motion variants being promoted to greater use (and potentially additional variation). Optionally, a period of initial experimentation is performed, e.g. with different batches of vials, e.g., according to patterns of injection which have been determined to be potentially preferable.

### Non-Solution Mixtures

In some examples, mixing is used to form and/or homogenize mixtures (e.g., emulsifications and/or suspensions), without necessarily resulting in an optically clear solution. In some examples, an optically clear solution is the intended outcome, but there is potentially a phase of operations during which the solute and solvent are in a fully mixed suspension which can be depended on as sufficiently homogenized to end active agitation (e.g., such that dissolution will dependably complete on its own, given time available). Optionally, this has the potential benefit of reducing processing time, and allowing more efficient use of the pharmaceutical preparation apparatus.

In some examples, measurements of mixing state determine that a non-dissolved (e.g., suspended) substance is sufficiently homogeneous in distribution that mixing can be considered complete. In some examples, this comprises imaging a texture of portions of the suspended substance which can be visualized at the surface of a turbid mixture. For example, the texture of a visible surface of the mixture may be determined to be uniformly comprised of particles below a certain size, optionally during a period of time (and optionally motion and/or agitation) long enough that what has been visible at the surface can be considered sufficiently representative of the volume overall.

### Vial Fluid Contents Monitoring

An aspect of some examples of the presently disclosed subject matter relates to the automatic verification of fluid contents quantity in vials during the automatic mixing of pharmaceutical preparations.

In the case of vials provided and/or manipulated as containers of pharmaceutical substances, a requirement for verification of fluid volume may arise as part of operations making use of the contained pharmaceutical substance. For example, the contained pharmaceutical substance may be distributed in a solid form, intended to be dissolved into a certain amount of injected liquid (e.g., saline) before removal from the vial (e.g., removal in a dissolved concentration which is expected to be known). In an automated system, there may be an assessed risk in need of mitigation that an incorrect amount of liquid could be injected into the vial for this purpose. Additionally or alternatively, there may be an assessed risk in need of mitigation that a solid-contents vial is inadvertently substituted for dissolved-contents vial.

As mitigations and/or as part of sensing for control, non-visual means (e.g., scales) are a typical solution for use in automatically verifying fluid contents volume. This provides potential advantages for sensitive quantitative verification of the movement of materials in the system. Associated, however, are potential issues of calibration, delicacy of the sensors involved, and/or system time used to place materials and/or allow scale readings to settle.

Some examples of the presently disclosed subject matter make use of optically identifiable (visual) indications of the quantity of liquid contents in a clear-walled container. An important type of such indication comprises a contrasting boundary region at the interface between a liquid phase of the contents of the vial, and a (typically) gaseous phase of the contents of the vial (e.g., air or another gas). In some examples (additionally or alternatively to a gaseous phase), there is a liquid/liquid boundary between unmixed liquids; e.g., a boundary between a more-dense liquid such as an aqueous solution, and a less-dense liquid such as an oil or other non-aqueous liquid. The boundary region is also referred to herein as an “upper” boundary, region insofar as it it a boundary region above the bottom of the vial, and a boundary region which is at an upper side of a material phase of the vial contents. It is not necessarily the “uppermost” such boundary, e.g., there may be three material phases in a vial, with a boundary layer between each sequential pair of material phases.

In images of the vial obtained using an optical camera, the boundary region may be visible at a location where it extends across the interior surface of a transparent wall of the vial. This location may be somewhat imprecisely localized, although visible. For example, its appearance can be distorted by optical properties of the container walls, and/or influenced by the 3-D shape of a fluid meniscus formed by the liquid at its surface. The meniscus shape is curved according to a balance of fluid surface tension and attraction of the liquid to walls of the container. These forces can vary according to the specific properties of either; e.g., they are sometimes affected by even relatively small amounts of solute in the liquid.

Visibility of the boundary region (that is, effects on pixel intensities in an image of the vial) is a result of differences in one or more optical properties of the material phases which make up the vial's contents. Examples include differences in refractive index (particularly for boundaries between optically transparent substances), optical absorption, scattering, and/or reflecting at one or more wavelengths. Differences in refractive index between liquid contents and the material of the container wall itself also affect the actual and/or imaged shape of the boundary region. Effects of refraction also potentially introduce uncertainty into the structure of the container as inferred from images alone. For example, vial wall thickness may be optically distorted, with the amount of distortion jointly depending on vial geometry and the refractive index of its material.

Moreover, the utility of visual assessment (e.g., verification) of fluid volume using the boundary region is potentially impeded by the presence of labeling which obscures a large portion of the vial wall. If there is a gap in the label, it may be small, and/or it may be inconveniently and/or unpredictably oriented. This, along with confounding effects such as those mentioned above, makes visual assessment of vial liquid contents potentially undependable.

The inventors of the present disclosure have determined, nonetheless, that under certain circumstances with potential significance in the field of automated pharmaceutical preparation, image-based assessments of fluid quantities in vials (including labeled vials) can be performed in a manner which potentially reduces or removes a requirement for weighing and/or otherwise performing secondary verification of fluid quantities in vials.

Briefly, the imaged-based assessment, in some examples, comprises imaging of the vial while the boundary region is oriented obliquely and/or perpendicular relative to the bottom of the vial. This is also referred to herein as a change in tilt angle of the vial, relative to the boundary region. Typically, the vial itself is tilted away from a vertical (upright) orientation (e.g., while the boundary region remains horizontal). However, it is not excluded that the vial is subjected to movements (e.g., rotational movements) exerting forces which induce the boundary region itself to orient oblique to the direction of gravitational pull, with or without tilting of the vial itself away from its upright orientation. The tilt angle is selected, for example, to place at least a portion of the boundary layer outside of areas obscured by labeling, and/or optionally to satisfy other conditions of imaging, calibration and/or a processing algorithm; for example as described herein. In some examples, the tilt angle is selected to place the boundary layer where it is visible (and/or expected to be visible) through the bottom of the vial.

Insofar as the boundary region is detected at all, it is an indication at least that the vial contains fluid. This allows, for example, verifying at least that a vial of an originally dry substance placed in the pharmaceutical preparation system has gone through an earlier step of receiving fluid. The boundary layer may be identified, e.g., by a characteristic shape, by a characteristic intensity profile, and/or by characteristic behavior in response to movement of the vial; for example, as the vial assumes different tilt angles, and/or as the vial undergoes acceleration. These are each examples of a target criterion to which the image may be compared.

In some examples, and considered together with the tilt angle of the vial (optionally along with suitable assumptions about the interior geometry of the vial), the boundary region location can be used to estimate the volume of a vial's fluid contents. This estimate is optionally performed with a selectable level of expected precision.

For example, even a roughly estimated volume (e.g., within ±20% of a precise figure) can often be sufficient for verification purposes. The target volume (optionally expressed as a range and/or with a tolerance specification) is also an example of a target criterion to which image-derived measurements may be compared, e.g., a position of the boundary layer in the image is optionally involved in a comparison according to its conversion to an associated volume estimate using suitable calculations.

The original pharmaceutically active substance in a vial may be a solid in a separately verified amount (e.g., sufficiently verified in itself), with the role of added fluid being primarily to dissolve it. Minor deviations in the fluid quantity may be negligible (e.g., when a vial's whole contents are anyway to be used at once within a much larger volume), may be adjusted for during remaining steps in pharmaceutical preparation, and/or may be adjusted for at the time of pharmaceutical administration.

In some examples, one or more calibration vials and/or calibration states of a vial known and/or confirmed to contain certain (e.g., targeted) fluid quantities and/or compositions are used as a reference. This allows fluid quantities in other imaged vials and/or vial states to be assessed on the basis of the boundary region position and vial angle alone.

The calibration state is optionally expressed, for example, as a position of the boundary layer, a result of comparing images showing the boundary layer (e.g., subtracting, correlating, or otherwise comparing two images to establish a metric of similarity or difference), or another state. In some examples, the comparison is performed using a product of machine learning; e.g., a product of machine learning trained on evaluations of boundary layer positions. Each of these are also examples of target criteria to which a boundary layer position may be compared.

In some examples, images of vials which are themselves used in pharmaceutical preparation are used to help set system requirements, e.g., for risk scenarios where the concern is to mitigate rare or intermittent deviations from a typical fluid volume. In some examples, a system operator approves results of system operations to mix a pharmaceutical preparation, e.g., approves a final result, and images taken during the mixing are optionally treated as representing valid results of intermediate pharmaceutical preparation operations. Additionally or alternatively, the system operator approves images or other measurements which directly indicate results of intermediate operations. For example, the system operator inspects an image of a boundary layer in a fluid vial and approves it as a standard for comparison. Additionally or alternatively, a system operator certifies that starting conditions are valid, and images of the vial are accepted as correlated indications of a valid quantity of fluid in the vial, based on the certification. The system operator may be, for example, a person directly providing instructions to the system, or a person who serves as an auxiliary monitor of system operation. In some examples, another automated system is provided in place of the system operator, e.g., an automated system specifically configured to validate pharmaceutical preparations according to suitable criteria of measured volume, composition, and/or other inputs.

Additionally or alternatively, precision in the volume estimate (optionally with or without use of a calibration vial) is optionally improved by taking a larger number of potentially confounding factors into account, e.g., parameters of vial interior shape and/or fluid meniscus shape. There are potential advantages in being able to flexibly switch between quantitative and qualitative verification levels (of optionally variable precision), since this allows adjusting the time and/or effort applied in measurements to suit particular requirements for verification and/or risk mitigation.

In cases for which further characterization of an “upright” orientation of the vial is needed for removal of doubt, this orientation may be identified from features such as that the vial is oriented to allow (when unsupported) stably resting on a substantially horizontal bottom or portion thereof, e.g., resting on a flat surface, a full or partial ring, and/or on small protrusions such as bumps or knobs. Additionally or alternatively, where the vial is provided with a septum, the septum is uppermost, and typically oriented horizontally. Typically, but not necessarily, a vial in an upright position includes a lower contents-containing volume which is cylindrical or prismatic (e.g., constant in cross section, ignoring volumetrically minor deviations such as bottom surface concavities). The cross-section is typically round, but other cross-section shapes are not excluded, e.g., ovals, ellipses, triangles, quadrilaterals, or other shapes. In such cases, at least when the vial is also provided with a flat bottom and horizontally oriented bottom, a longitudinal axis of the cylinder or prism extends along the vertical direction when the vial is upright. Optionally, an orientation of vial labeling such as text provides an indication of vial orientation.

In some examples, one or more automatic actions taken using the vial are performed based on the image-based assessment of the vial's contents, e.g., based on the presence of fluid, and/or the amount of fluid (e.g., a liquid fluid). In some examples, the automatic actions are determined as one or more uses of the vial contents, or rejection of use of the vial contents. In some preferred examples, the use/rejection relates to use of the contents in automated preparation of a pharmaceutical preparation. For example, it may be uncertain whether or not to continue with use of the vial, pending validation of the quantity of fluid contents in a vial.

In some examples, the determined use of the vial comprises use together with additional adjustments to the contents of the vial. For example, the use optionally comprises addition of more fluid to make up a deficit. Alternatively, (e.g., in a case where an ingredient is found to be over-diluted in a too-large volume), the fluid is combined with contents of another vial for which an added volume of fluid has been intentionally or accidentally reduced so that combined concentrations are corrected thereby to target levels. In some examples, the determined use of the vial comprises operations to reset the vial orientation to a specific position in preparation for further activity. For example, the vial is returned to an upright position to allow fluid to be withdrawn from it; or placed in a fully inverted position for the same purpose. In some examples, the vial is returned to an upright position and moved to be placed in a reject area, or returned to its original position (as a reject) without being further used.

### Terminology

Subject matter of the present disclosure generally relates to robotic pharmaceutical preparation systems, and more particularly to fluid transfer stations within a robotic pharmaceutical preparation system. It is to be understood that, for brevity and clarity, examples described herein (with reference to the drawings and otherwise) are described with reference to component subsets of pharmaceutical preparation systems; e.g., particular aspects of the overall fluid transfer apparatus assembly. Furthermore, examples straightforwardly analogous to examples described herein should be understood as being encompassed within the scope of the present disclosure. This includes, for example, particular implementations and/or combinations of elements and/or subsystems different in detail than explicitly described, but alike in function and/or functional role.

Pharmaceutical preparation systems: Embodiments of robotic pharmaceutical preparation systems and the fluid transfer stations thereof described herein are configured for performing operations related to transfer of pharmaceuticals between different fluid transfer apparatuses.

Robotic pharmaceutical preparation systems (which may alternatively be referred to as “robotic systems”) according with the subject matter of the present disclosure include elements and/or subsystems such as robotic stations, robotic arms, motors, control units, and/or other mechanisms which operate to perform, control, and/or verify fluid transfer. These elements are optionally designed and/or described as making up and/or made up of units and/or subsystems operable for performing activities related to preparation of pharmaceuticals designated for administration to patients. For example, a robotic system may comprise one or more automatic or partially automatic subsystems comprising at least one manipulator controlled at least partially by a controller unit (equivalently referred to as controller or control unit). Controller units may themselves be arranged in communication with each other, e.g., hierarchically, and/or in a network, in order to coordinate overall functioning of the pharmaceutical preparation system.

Pharmaceutical preparation system described herein perform fluid transfer between fluid transfer apparatuses designated containers and fluid transfer units, with the latter often acting as the intermediate element (typically but not necessarily also the “active” element, e.g., the element through which pressure is generated which results in fluid movement), and the former being considered as the fluid source or fluid receiving element (typically but not necessarily a “passive” element). The fluid transfer may be assisted by a fluid transfer connector. However, an ordinarily intermediate fluid transfer unit may nevertheless optionally operate as an initial source of a fluid (e.g., in the form of a pre-filled syringe provided at the beginning of pharmaceutical preparation), and/or as a final receptacle for fluid (e.g., in the form of a filled unit which passes onward to another process such as delivery to a patient, storage, or another purpose). Nor is it excluded that a container takes on an intermediate role as both a fluid source and as a fluid receiver.

Embodiments of transfer apparatuses may comprise, for example, one or more conduits, pumps, syringes, vials, intravenous bags, adaptors, and/or needles. Optionally, these elements are consumables and/or accessories of the pharmaceutical preparation systems. Optionally, such elements are nevertheless considered as pharmaceutical preparation system components. The term vial in particular is used herein as a term for containers in which contents beginning in a solid and/or relatively concentrated form are initially dissolved and/or diluted. In other examples, a vial contains an amount of fluid whether or not it was originally a container for a solid and/or concentrate. In other examples, the vial may still retain a substance in its solid and/or concentrated form. However, the term vial is not limited to this list of example cases.

Fluid: As referred to herein, “fluid” typically comprises a pharmaceutical, a diluent, saline solution, water, or any other fluid used in pharmaceutical preparation. Fluids may be understood more specifically to be provided as liquids, although the use of gaseous fluids is not excluded, insofar as their characteristics are consistent with descriptions herein.

Fluid transfer: “Fluid transfer” is performed in between a container assembly and a fluid transfer assembly via openings formed in a port of the container assembly or fluid transfer assembly and/or via openings formed in a septum of the container assembly or fluid transfer assembly.

Septum: Herein, a “septum” generally refers to a membrane configured to close access to a part of a device to which it belongs. A septum on a container or container connector (also referred to as container-septum) may seal the container. A septum on a fluid transfer assembly (also referred to as fluid transfer connector septum) may prevent or resist access to and/or by a fluid transfer conduit. Typically, a septum is made of a resilient pierceable material. Such material may be a polymer with elastic properties like rubber. A vial, for example, is often provided with a cap having an integrated septum.

Container: In performing fluid transfers, robotic systems operating in accordance with the present disclosure optionally manipulate, and/or inspect variously embodied containers. A “container” as described herein optionally refers to any one or more of: syringes, IV bags, elastomeric pumps, vials, bottles, ampules, syringes, conduits, pipes, or generally any vessel or receptacle suitable for holding fluids or liquids. It is further to be understood that the container can be any other element functioning as a component of a fluid transfer apparatus, with or without a connector (or “adaptor”) for establishing fluid communication of the container with other fluid transfer components. For example, the container can be a vial along with a vial adaptor, or an intravenous bag along with a spike adaptor. The container can be accessible via a container septum which can be a septum of the container lid or can be a part of the connector. In a process of fluid transfer performed using fluid pressure changes and/or differentials, a container characteristically experiences transfer of fluid due to a pressure change generated in and/or via a fluid transfer assembly with which it is connected.

Vial: As referred to herein, a “vial” (e.g., referring to a certain container) may include a closable vessel, formed for example of glass or plastic, such as an ampule or bottle, and containing a pharmaceutical in liquid or powder form. The vial can be a single or multiple use vial. The vial can be tubular or bottle shaped, having a neck portion in proximity to the vial opening. The vial can be topped with a cap, e.g., a cap with a septum. Vials are typically fixed in shape, and in particular fixed with a constant internal volume, although the volume may be filled to a greater or lesser extent. Vials, in some examples, are also preparatory vessels, in which the substances they supply are dissolved, diluted and/or reconstituted in preparation for further operations such as transfer into a syringe. Accordingly, operations performed on a vial commonly include one or both of injecting fluid and removing fluid. In between, there may be mixing operations which dissolve and/or dilute an originally contained substance with injected fluid. Vials are often supplied for use in manual preparation options, and not necessarily standardized in size. Vials may be provided with labeling suitable for manual operations, but with potential disadvantages for automated operations such as the disadvantage of obscuring a view into the contents of the vial.

Container assembly: As referred to herein, a “container assembly” may include: a container alone, or a container onto which a container connector is mounted. The term “vial assembly” is used equivalently, although examples embodying aspects of the present disclosure do not necessarily include a vial in a strict sense (e.g., an ampule may be present instead). A septum for at least partially sealing access to the vial can be located as part of the vial itself and/or as part of a container connector (equivalently referred to as a “vial adaptor” or “container adaptor”). The container connector may include a device mountable onto a vial, for facilitating transfer of the vial itself (by grasping onto the adaptor instead of grasping the vial) and/or for facilitating fluid transfer into or from the vial. The container connector may provide protected (e.g., “closed” and/or maintaining sterility) access to the contents of the vial. The container connector may be a single use or multiple use, sterilized device. A vial in a container assembly may be in part obscured from view by elements that attach to it, e.g., manipulators that hold it for manipulations such as shaking or exchange of fluids.

Manipulator: As referred to herein, a “manipulator” may include a structure and/or a mechanism configured to controllably interact with at least one container (e.g., a container loaded onto the system) and/or with other components or structures of the pharmaceutical preparation system. The manipulator can be configured to move the at least one container. The manipulator can be configured to cause or urge fluid transfer processes; for example, transfer fluid from one container to another, involving for example withdrawal of fluid and/or insertion (e.g., injection) of fluid. The manipulator may comprise a robotic arm, a platform, a robotic station, or a combination thereof configured for manipulating the container and/or the fluid transfer assembly. The manipulator can include an actuator, e.g., a motor for facilitating its operation. Certain manipulators are also referred to herein as “agitators”. In some examples, an agitator comprises a manipulator provided with an agitation-specific capability (e.g., a capability for oscillating motions, separate from a capability of the manipulator for selectively positioning manipulated containers in a targeted location). In some examples, the agitator is more simply characterized by being able to secure a container (e.g., a vial) while itself moving in an agitated fashion, e.g., oscillating in position with to impart motion to container contents. In some examples, the agitator moves to impart vortical motion to fluid contents of the container. In some examples, the agitator moves to disrupt a surface boundary region of fluid contents of the container; e.g., to create splashing, and/or momentary droplet separation. In some examples, the agitator generates currents in fluid contents of the container. In some examples, the agitator imparts motion to contents of the vial which induces mixing between two material phases of the contents of the vial, for example, suspending and/or dissolving a solid material into a liquid material, and/or suspending and/or dissolving two liquid material into a common material phase.

Manipulators are not necessarily implemented as “arms” as such, even when described in relation to such terminology. Fluid transfer may occur while a container is engaged (e.g., gripped) by a manipulator. In an example, a manipulator (e.g., a “gripper” or “plunger arm”) can include one or more actuators used in engaging a syringe, and/or pulling or pushing a plunger of a syringe. The syringe may in turn be engaged with a vial. Manipulators are optionally configured to manipulate other types of fluid containers such as vials, IV bags, tubing and/or another suitable container.

Controller: Herein, the equivalent terms “controller” and “controller unit” generally refer to circuitry configured to command some aspect of the behavior of a controlled element, e.g., operation of an actuator (which in turn may be an actuator of a manipulator), operation of a sensor, and/or operation of an imager. The controller, in some examples, comprises computerized circuitry (also referred to herein as “processing circuitry”) configured to perform operations in accordance with a set of instructions stored on a memory readable by the controller, which may be executed, e.g., by a central processing unit (CPU), one or more processors, processor units, and/or microprocessors. Additionally or alternatively, in some examples, the controller uses a digital signal processor (DSP), field-programmable gate array (FPGA), specialized application specific integrated circuit (ASIC), or another device. Additionally or alternatively, in some examples, a controller or controller unit includes one or more analog (e.g., amplifier feedback-based) and/or low-level logic gate-based control circuits. In some examples, the control unit can include one or more mechanism controllers. The controller unit may comprise any means to control elements in the robotic pharmaceutical preparation system and may comprise at least one of analog control circuitry, a synchronizing unit, and a processor.

Imager: Herein, the term “imager” refers to any device which operates to produce an image of some target. “Optical” imaging may typically be understood to include imaging of light including visible light, but this is not necessarily required. For example, infrared and/or ultraviolet wavelengths may be used in imaging additionally or alternatively to visible light wavelengths as appropriate. An example of an imager is an optical camera; e.g., a camera equipped with one or more transparent lenses and a light sensor which can be read out to produce a digital image. Optionally, a scanning imaging method is used, e.g., imaging of reflectance returned to a sensor from a laser illumination scanned over the target. Optionally, interferometric imaging is used, e.g., to track small deformations and/or movements. Imaging using radiant energy other than visible light is not excluded; e.g., acoustic energy, electromagnetic wavelengths outside of the visible spectrum, and/or particle (with mass) radiation imaging. Optionally, contact imaging is performed, e.g., a contact probe is moved along an imaged target to confirm accuracy of its positioning and or measure one or more contours of its shape.

Herein, characteristics and/or values may be referred to as “expected” or “targeted”. It should be understood that these terms refer to technologically embodied representations of appropriate respective states and/or quantities. Optionally, such representations are numeric, e.g., as in the case of targets stored by digital computing circuitry. Optionally, such representations are analog and/or mechanical; for example, represented by a setting of a pointer, knob, weight, or other element or arrangement of elements.

Before explaining at least one embodiment of the present disclosure in detail, it is to be understood that the present disclosure is not necessarily limited in its application to the details of construction and the arrangement of the components and/or methods set forth in the following description and/or illustrated in the drawings and/or given in the Examples. drawings Features described in the current disclosure, including features of the invention, are capable of other embodiments or of being practiced or carried out in various ways.

### Visual Inspection for Solute Dissolution in Solvent

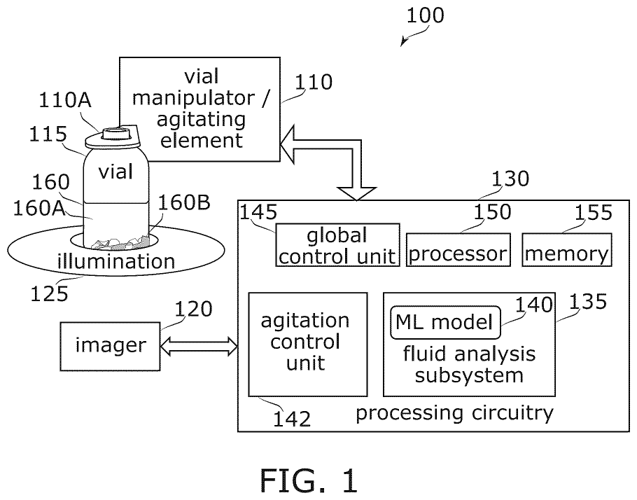

Reference is now made to FIG. 1, which schematically illustrates a block diagram of an example system 100 configured for controlled dissolution of a solid into a fluid, according to some examples of the presently disclosed subject matter. In some examples, system 100 is a subsystem of a robotic pharmaceutical preparation system which operates to create pharmaceutical preparations by the measured transfer of fluids between a plurality of containers.

Vial 115, in some examples, is a container containing a fluid-solid mixture. It is introduced for manipulation by system 100, e.g., by previous robotic picking from a storage area and/or by manual placement.

In some examples, vial 115 initially contains a powdered (e.g., lyophilized and/or ground) and/or crystalline substance. This may be mixed together with a fluid solvent (e.g., a saline solution or Ringer's solution); for example, a fluid solvent injected into vial 115 in an earlier stage of processing by the robotic pharmaceutical preparation system.

In some examples, vial manipulator/agitator 110 comprises a mechanical component 110A which operates to grip (or otherwise hold, e.g., contain) and move vial 115. By way of non-limiting example, vial manipulator/agitator 110 can be a robot arm with a gripping implement at its end suitable for gripping and manipulating the vial.

In some examples, the agitating component of vial manipulator/agitator 110 is operable to apply a rotating motion to vial 115; for example, a looping (e.g., circular) and/or reciprocating rotary motion in one, two, or three axes; in clockwise or counterclockwise directions; and in movements that are between 0 and 360 degrees (or more for repeated loops).

By way of non-limiting example: vial manipulator/agitator 110 optionally rotates vial 115 in alternating movements that begin by moving the vial 115 90° clockwise in the x direction, then 180° counterclockwise in the x direction, and finally 90° clockwise back to the original position. The motion is optionally repeated any suitable number of times.

By way of further non-limiting example: vial manipulator/agitator 110 might rotate the vial 115 360° in the z direction, e.g., rotating to invert vial 115, and then continuing the rotation to restore vial 115 to its original orientation.

In some examples, the agitating component of vial manipulator/agitator 110 can cause a manipulated vial 115 to be displaced (for example, linearly displaced) in one, two, or three axes, in forwards and/or backwards directions (that is, reciprocating). The movement distances and speeds are optionally of any suitable magnitude.

In some examples, vial manipulator/agitator 110 is operable to cause a manipulated vial 115 to move in sequences including any of the movements described above; simultaneously and/or in succession.

The term “shaking” as used herein refers to any type of movement applied to vial 115 which can be suitable for accelerating a rate at which a solid or fluid solute dissolves into a fluid solvent. Such acceleration of a rate of dissolution may be due at least in part, for example, to solvent movement past the material washing away solute as it dissolves, thereby maintaining a relatively steep concentration gradient into which remaining material continues to diffuse. Optionally, the acceleration of a rate of dissolution is due at least in part to the exercise of mechanical forces (e.g., shearing and/or impact forces) on the solute which fragment it and/or increase its effective surface area. The latter mode of acceleration is potentially prone to variable effectiveness, e.g., depending on how fluid is made to move within its container, and/or how the material being dissolved responds to mechanical forces.

Optionally, illumination 125 is positioned to illuminate the contents 160 of vial 115. For example, illumination 125 optionally comprises ring illumination which surrounds vial 115. Optionally, illumination 125 is provided from another light source, for example, a panel or spot source. However configured, illumination 125 provides lighting suitable to enable imager 120 (e.g., an optical camera) to capture images of the fluid 160A and/or solid 160B contained in vial 115.

Imager 120 can be any suitable type of digital camera or other imaging device. Imager 120 can be positioned, for example, beneath vial 115, so as to view the content of the vial from its bottom surface. This has the potential Advantage of avoiding occlusion by labels or other matter on the walls of vial 115. In some examples, imager 120 is positioned in another suitable location.

Processing circuitry 130 can be operably connected to imager 120 and to vial manipulator/agitator 110. In some examples, processing circuitry 130 can, for example, instruct imager 120 to capture an image of vial 115, and can then receive the captured image.

In some examples, processing circuitry 130 can instruct vial manipulator/agitator 110 to initiate or halt shaking, or change the parameters of shaking.

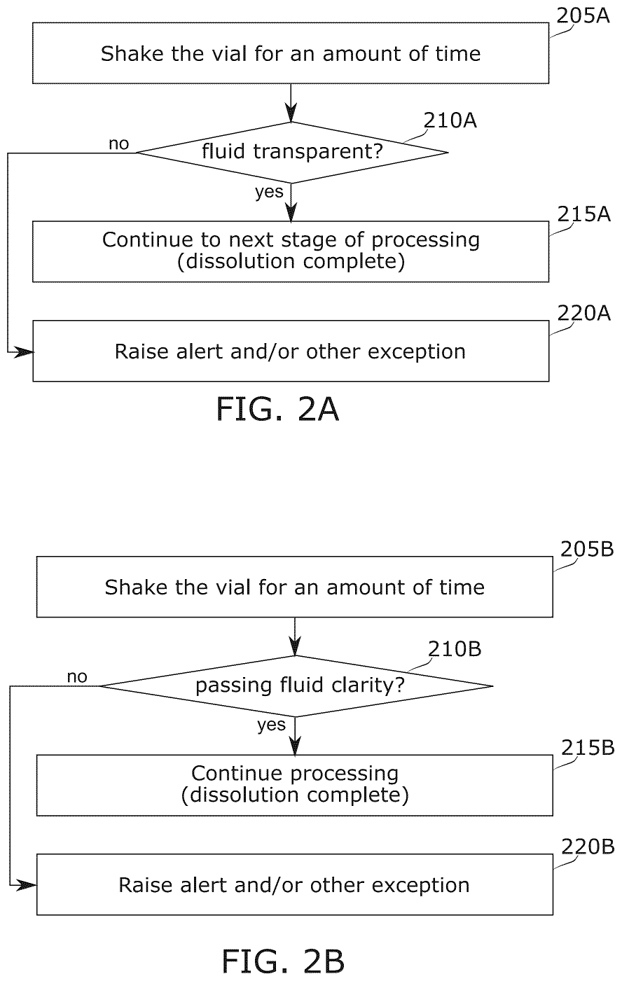

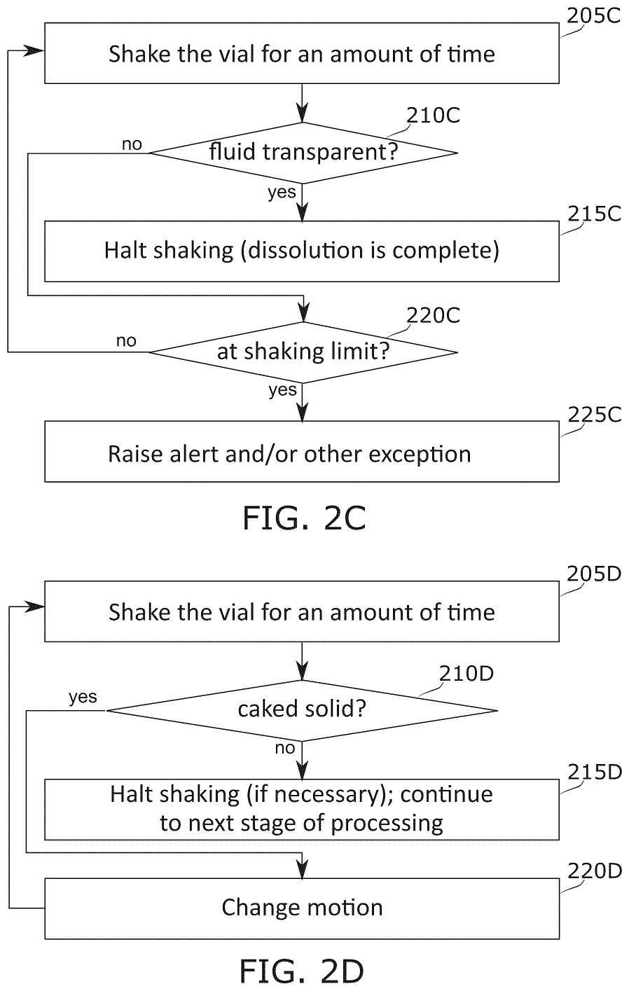

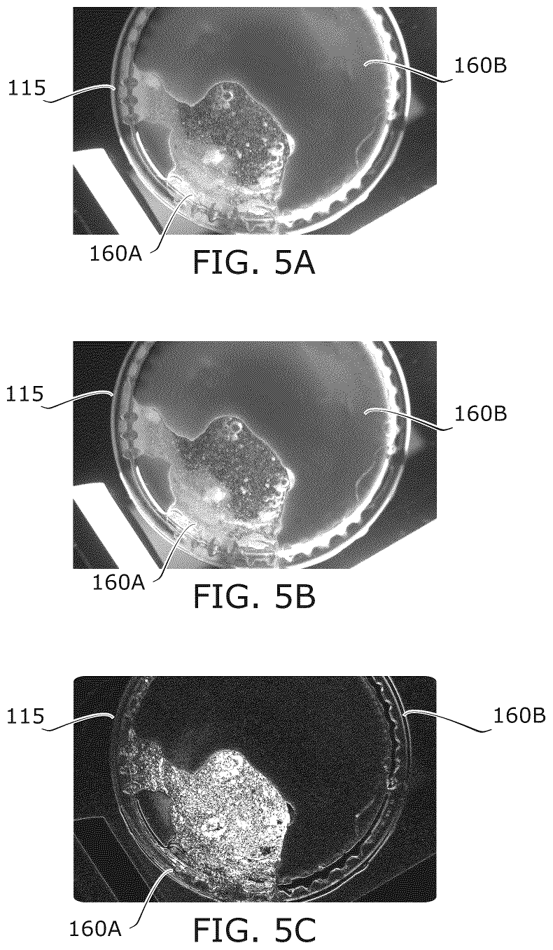

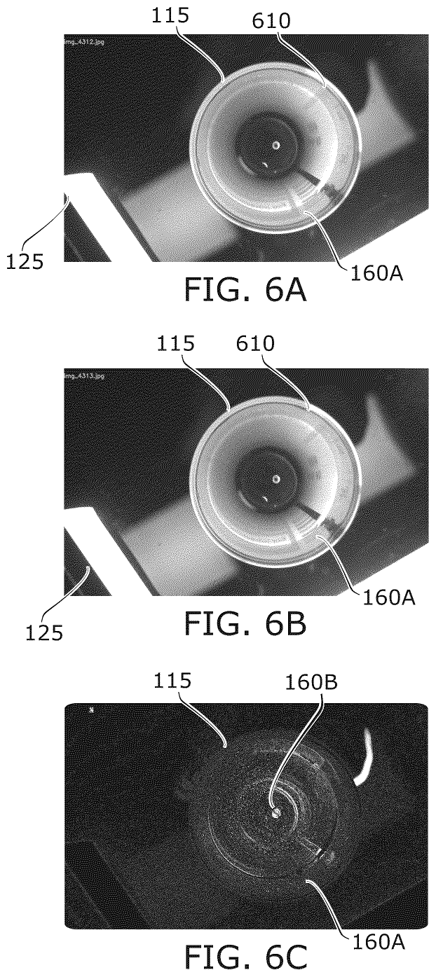

Processing circuitry 130 can include processor 150 and memory 155. In some examples, instructions performed by processor 150 to carry out one or more of the methods of the present disclosure are provided on a non-transitory digital storage medium. In particular, it should be understood that any of the computer-performed operations described in relation to FIGS. 2A-3 and/or FIGS. 7-8 are optionally associated with corresponding instructions to be performed by a processor 150 provided on a non-transitory digital storage medium.

Processor 150 can be a suitable hardware-based electronic device with data processing capabilities, such as, for example, a general-purpose processor, digital signal processor (DSP), a specialized Application Specific Integrated Circuit (ASIC), one or more cores in a multicore processor, etc. Processor 150 can also consist, for example, of multiple processors, multiple ASICs, virtual processors, combinations thereof etc.

Memory 155 can be, for example, a suitable kind of volatile and/or non-volatile storage, and can include, for example, a single physical memory component or a plurality of physical memory components. Memory 155 can also include virtual memory. Memory 155 can be configured to, for example, store various data used in computation.

Processing circuitry 130 can be configured to execute several functional modules in accordance with computer-readable instructions implemented on a non-transitory computer-readable storage medium. Such functional modules are referred to hereinafter as comprised in the processing circuitry. These modules can include, for example, agitation control unit 142, global control unit 145, fluid analysis subsystem 135, and machine learning model 140.

Global control unit 145 can perform global control functions such as moving a vial 115 to a different location in the pharmaceutical preparation device after dissolution of the solid into the fluid is complete.

Agitation control unit 142 can perform the control of vial manipulator/agitator 110.

Fluid analysis subsystem 135 can perform image processing on captured images of the fluid in vial 115, and can determine from the image whether the fluid and/or solid exhibit certain characteristics. Processing of vial 115 can then continue in accordance with the handling that is appropriate to the determined characteristics of the fluid, as will be described in detail hereinbelow.

By way of non-limiting example, fluid analysis subsystem 135 can, in various examples, determine one or more of the following types of characteristics of the fluid and/or solid:

Transparency or lack of transparency of the fluid/solid mixture. For example, images can be analyzed for the degree to which illumination passing through a vial is diminished in intensity (with less diminishing being correlated with greater transparency). This can include measurements of the intensity of light passing from a backlight though the vial to the imager, light passing into the vial from the side of the imager and then returning to the imager, and/or light taking another pathway, as appropriate.

A degree of fluid clarity of the fluid/solid mixture, or whether the fluid/solid mixture meets a certain required fluid clarity. In some illumination conditions, diminished intensity of light may be expected when there is diminished clarity; in other illumination conditions, light intensity may increase, e.g., as more light is reflected back from a turbid suspension. Optionally, uniformity of the image is also assessed, e.g., uniformity of particle size, particle velocity, or another metric. For example, under agitation, particles in a suspension may reflect a pattern of laser speckles which undergoes changes with shared and/or characteristic time-dependent statistics. Exposure time or another parameter is optionally selected to distinguish “blurring” areas of laser speckle motion from non-blurring areas. Non-blurring areas may be indicative of regions which are compacted with a substance rather than suspended.

It is noted that fluid clarity refers to the amount of light that can pass through a non-transparent fluid. For example, fluid clarity is potentially an indication of whether there is caking on an internal surface of vial 115.

Additionally or alternatively, there may be a mismatch between the fluid color observed and an expected or targeted fluid color. This can indicate, for example, that the type of solid is incorrect, or that the quantity of solid or fluid is incorrect. It is noted that the expected fluid color can itself be variable, dependent, e.g., on the type of solid and/or type of fluid that is in the vial.

In another example, fluid analysis subsystem 135 is configured to measure the presence of foreign particles in the fluid. This potentially indicates contamination of the solution, or damage to internal components of the vial. Foreign particles may be particles which have, e.g., an otherwise unexplained size, shape, or color. They may be particles which persist in a vial after other particles have dissolved. Optionally, such particles are distinguished from bubbles, e.g., according to their apparent density (e.g., settling instead of rising), and/or lack of transience.

In another example, there may be a mismatch between the fluid level and an expected fluid level. This potentially indicates leakage from the vial.

It is noted that the expected (targeted) fluid level can be variable, e.g., selected dependent on the quantity of fluid that was initially in the vial.

In some examples fluid analysis subsystem 135 utilizes a machine learning model 140. In this case, machine learning model 140 can be pre-trained to classify images as required.

For example, machine learning model 140 can be trained with images of transparent fluids and non-transparent fluids (e.g. with appropriate labeling in cases where supervised models are utilized). Fluid analysis subsystem 135 can then classify a runtime image to classify it as transparent or non-transparent. In some examples, the training (and thus the classification) can be specific to a particular solid type (i.e. particular medication) or particular fluid type.

In various examples, machine learning model 140 can be similarly trained to perform classification to distinguish fluids meeting a particular level of fluid clarity from those not meeting the level of clarity. Similarly, machine learning model 140 can be trained to identify the presence of foreign particles, color or tint of the fluid, and presence of caking on vial 115. In some examples, fluid analysis subsystem 135 and/or machine learning model 140 is used in a method such as the methods of FIGS. 2A-2F and/or FIG. 3.

Additionally or alternatively, fluid analysis subsystem 135 can use mechanisms known the art to estimate the fluid volume. In some embodiments, estimation uses a machine learning model 140 trained to perform classification to distinguish fluid presence and/or fluid levels in a vial. In some examples, fluid analysis subsystem 135 and/or the machine learning model 140 is used in a method such as the methods of FIGS. 7-8.

In some examples, fluid analysis subsystem 135 uses non-machine-learning image processing methods on a captured image, to determine characteristics of the fluid.

In some examples, fluid analysis subsystem 135 uses arrangements of measurement and/or analysis such as those described herein in relation to visual inspection for fluid presence and/or volume.

FIGS. 2A-2F illustrate various methods of controlling dissolution of a solid into a liquid. It is noted that various examples can utilize some or all of these methods, or utilize different methods altogether.

FIG. 2A illustrates a flow diagram of an example method of assuring dissolution of a solid into a fluid, as part of a process of pharmaceutical preparation in a robotic pharmaceutical preparation system, according to some examples of the presently disclosed subject matter.

The method illustrated in FIG. 2A can be appropriate to—for example—preparation of a medical solution that is fully transparent and results from fully dissolving a powder substance into a fluid (such as a saline solution or glucose solution).

The method illustrated in FIG. 2A can operate, for example, on a vial containing a powder substance which has had an appropriate amount of fluid injected into the vial.

Processing circuitry 130 (e.g. agitation control unit 142) can control vial manipulator/agitator 110 to shake 205A a vial 115 held by the vial manipulator/agitator 110.

After, for example, expiration of a particular time interval (for example: a time sufficient for dissolution of a particular solid into a particular fluid), processing circuitry 130 (e.g. fluid analysis subsystem 135) can evaluate (for example, by machine learning classification, as described hereinabove) whether the fluid is currently transparent 210A. In another example, transparency is evaluated by checking for a ratio of scattering of light to light which passes straight through the vial. In another example, transparency is evaluated according to the contrast and/or legibility of an image target positioned on an opposite side of the vial.

It is noted that in some examples, the transparent fluid can be colored. In such examples, there may be a spectral parameter which is characteristic of the dissolved fluid and/or its concentration; for example, a ratio of light measured at two different wavelengths.

If the processing circuitry 130 (e.g. fluid analysis subsystem 135) determines that the fluid in the vial 115 is indeed transparent, processing circuitry 130 (e.g. global control unit 145) can then control the vial manipulator/agitator 110 to continue 215A to the next stage of the pharmaceutical preparation process.

If the processing circuitry 130 (e.g. fluid analysis subsystem 135) instead determines that the fluid is not transparent (at least, according to the transparency criterion being used), processing circuitry 130 (e.g. global control unit 145) can raise 220A an alert indicating that the solid did not properly dissolve in the fluid (for example: by displaying a message on a management display unit). In some examples (additionally or alternatively), another form of exception handling is performed; e.g., use of a vial may be rejected, and optionally another vial selected with which to continue operations.

It is noted that the teachings of the presently disclosed subject matter are not bound by the flow diagram illustrated in FIG. 2A. It is also noted that whilst the flow chart is described with reference to elements of the system of FIG. 1, this is by no means binding, and the operations can be performed by elements other than those described herein.

FIG. 2B illustrates a flow diagram of another example method of controlling dissolution of a solid into a fluid, as part of a process of pharmaceutical preparation in a robotic pharmaceutical preparation system, according to some examples of the presently disclosed subject matter.

The method illustrated in FIG. 2B can be appropriate to—for example—preparation of a medical solution that is not fully transparent after fully dissolving a powder substance into a fluid.

Accordingly, the steps of the method of FIG. 2B are similar to the steps of the method of FIG. 2A. However, following the shaking and expiry of the time interval 205B, processing circuitry 130 (e.g. fluid analysis subsystem 135) can evaluate (for example, by machine learning classification, as described hereinabove) whether the fluid clarity meets a fluid clarity criterion 210B.

If so, then processing circuitry 130 (e.g. global control unit 145) can continue 215B processing, and if not, processing circuitry 130 (e.g. global control unit 145) can raise 220B an alert. In some examples (additionally or alternatively), another form of exception handling is performed; e.g., use of a vial may be rejected, and optionally another vial selected with which to continue operations.

It is noted that the teachings of the presently disclosed subject matter are not bound by the flow diagram illustrated in FIG. 2B. It is also noted that whilst the flow chart is described with reference to elements of the system of FIG. 1, this is by no means binding, and the operations can be performed by elements other than those described herein.

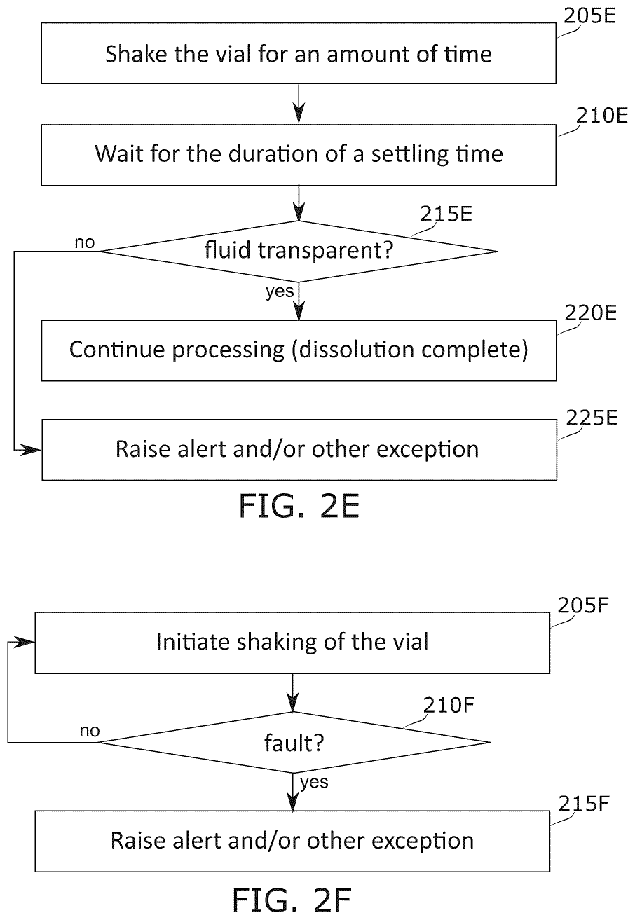

Brief reference is now made to FIG. 4B, which is a photographic image of a vial including foreign particles, in accordance with some examples of the present disclosure. Under the illumination conditions present, clear (transparent) areas are seen as black, while foreign particles appear as granules such as particle 160B. Identification of these particles is optionally performed using machine vision methods such as edge detection, thresholding, and/or particle size filtering. Optionally, machine learning methods are used to train the distinction between foreign particles and other image elements of no particular concern, such as small bubbles and reflections from vial surfaces.

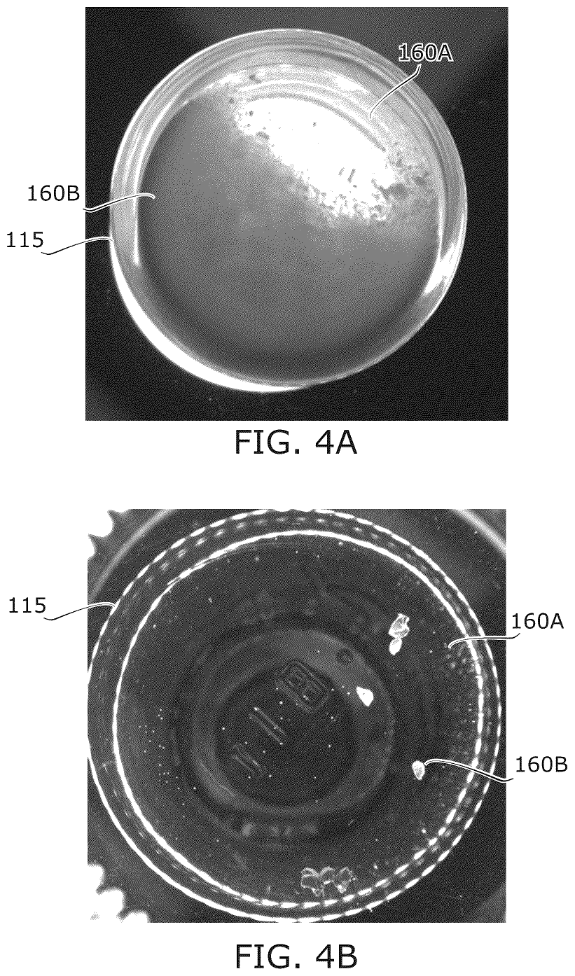

Brief reference is also made to FIGS. 6A-6B, which are photographic images of a vial including foreign particles, in accordance with some examples of the present disclosure. Further brief reference is made to FIG. 6C, which is an absolute value differential image constructed from the images of FIGS. 6A-6B, in accordance with some examples of the present disclosure. Although the features present and imaging conditions are different (e.g., with illumination 125 located to the lower left of FIGS. 6A-6B, and a large bright label 610 wrapping vial 115), the presence of a large particle can still be easily distinguished in FIG. 6C. Additional processing is optionally performed, e.g., to mask, filter, and/or otherwise enhance visibility of particles. Optionally, machine learning classification is performed on raw images and/or on images preprocessed to enhance the visibility of potential fault conditions.

FIG. 2C illustrates a flow diagram of an additional example method of controlling dissolution of a solid into a fluid, as part of a process of pharmaceutical preparation in a robotic pharmaceutical preparation system, in accordance with some examples of the presently disclosed subject matter.

Optionally, the method illustrated in FIG. 2C is used to optimize processing time utilized for dissolution of a solid into a fluid, and to detect failure of dissolution. Additionally or alternatively, the method illustrated in FIG. 2C is utilized to dissolve a solid into a fluid in situations where time for dissolution is not known or is variable.

Processing circuitry 130 (e.g. agitation control unit 142) can control vial manipulator/agitator 110 to initiate shaking 205C of a vial 115 held by the vial manipulator/agitator 110.

Periodically, processing circuitry 130 (e.g. fluid analysis subsystem 135) can evaluate (for example, by machine learning classification, as described hereinabove) whether the fluid is currently transparent 210C. In examples where the resulting fluid is not expected to be transparent, processing circuitry 130 (e.g. fluid analysis subsystem 135) can instead evaluate whether the fluid clarity meets a fluid clarity criterion.

If the processing circuitry 130 (e.g. fluid analysis subsystem 135) determines that the fluid in the vial 115 is indeed transparent (or that the clarity meets the clarity criterion), then processing circuitry 130 (e.g. agitation control unit 142) can halt 215C the shaking of the vial 115 by the vial manipulator/agitator 110. Processing circuitry 130 (e.g. global control unit 145) can then control the vial manipulator/agitator 110 to continue to the next stage of the pharmaceutical preparation process.

If the processing circuitry 130 (e.g. fluid analysis subsystem 135) instead determines that the fluid is not transparent (or that the clarity does not meet the clarity criterion), processing circuitry 130 (e.g. global control unit 145) can evaluate 215C whether a shaking limit (e.g. a time limit) has been reached, and if so processing circuitry 130 (e.g. global control unit 145) can raise an alert 225C. If the shaking limit has not been reached, processing circuitry 130 (e.g. fluid analysis subsystem 135) can continue shaking 205C the vial 115, and then re-evaluate whether the fluid is transparent (or whether the clarity meets the clarity criterion).

Thus, the method illustrated in FIG. 2C enables the shaking period to closely match the actual time required for dissolution of the solid into the fluid. It is noted that the method illustrated in FIG. 2C utilizes capabilities of fluid analysis subsystem 135 to evaluates fluid transparency/clarity during the shaking, thereby providing an efficient process which maintains continuity of processing, and reduces times for dissolution—in comparison with prior art systems which evaluate fluid transparency/clarity while vial 115 is stationary.

It is noted that the teachings of the presently disclosed subject matter are not bound by the flow diagram illustrated in FIG. 2C. It is also noted that whilst the flow chart is described with reference to elements of the system of FIG. 1, this is by no means binding, and the operations can be performed by elements other than those described herein.

FIG. 2D illustrates a flow diagram of an example method of handling caking of a solid on a vial surface during dissolution of a solid into a fluid, as part of a process of pharmaceutical preparation in a robotic pharmaceutical preparation system, according to some examples of the presently disclosed subject matter.

Processing circuitry 130 (e.g. agitation control unit 142) can control vial manipulator/agitator 110 to shake 205D a vial 115 held by the vial manipulator/agitator 110.

After, for example, expiration of a particular time interval (for example: a time sufficient for dissolution of a particular solid into a particular fluid), processing circuitry 130 (e.g. fluid analysis subsystem 135) can evaluate (for example, by machine learning classification, as described hereinabove) whether there is caking 210D of the solid on the vial surface. It is noted that in some examples, processing circuitry 130 (e.g. fluid analysis subsystem 135) can also (serially or simultaneously) evaluate for other conditions (such as transparency or clarity of the fluid).

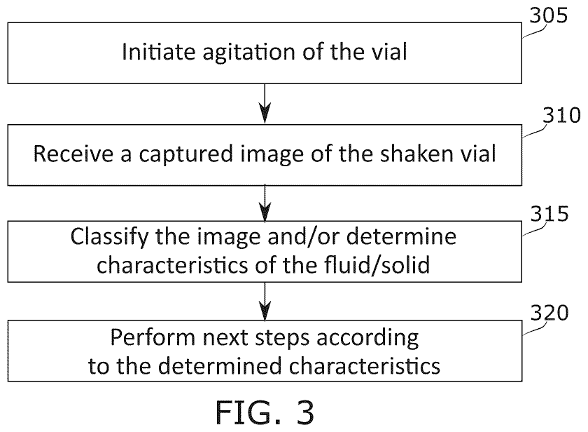

Reference is now made to FIG. 4A, which is a photographic image of a vial (captured from beneath the vial) in which caking of the solid is present, in accordance with some examples of the presently disclosed subject matter. The image is an example of an image measurement obtained by an imager 120 from a position located beneath vial 115, looking up at the contents. Reference is also made to FIGS. 5A-5B, which are photographic images of a same vial with caked solid, in accordance with some examples of the presently disclosed subject matter. Further reference is made to FIG. 5C, which is a differential image obtained by subtracting the images of FIGS. 5A-5B from each other (in absolute value), accordance with some examples of the presently disclosed subject matter.

In some examples, processing circuitry 130 (e.g. fluid analysis subsystem 135) determines whether caking according to a classification of a vial image by a machine learning model that was pre-trained using images of vials with and without caking of solids (with appropriate labeling).

In some other examples, processing circuitry 130 (e.g. fluid analysis subsystem 135) determines that caking is present if dissolution is not complete (e.g. the fluid is not transparent). For example, the (absolute value) differential image of FIG. 5C shows “white” motion signal due to fine-scale differences in reflectance in the circulating fluid contents 160A, while solid 160B remains dark, since there is no relative motion here.

It is further noted that in some examples, processing circuitry 130 (e.g. agitation control unit 142) can halt shaking of vial 115 after the expiration of the time interval and before the evaluation of whether caking is present, whereas in other examples shaking can continue during the evaluation of whether caking is present.

If the processing circuitry 130 (e.g. fluid analysis subsystem 135) determines that the fluid in vial 115 is free of caking, then—as appropriate—processing circuitry 130 (e.g. agitation control unit 142) can halt the shaking of the vial 115 by the vial manipulator/agitator 110. Processing circuitry 130 (e.g. global control unit 145) can then control the vial manipulator/agitator 110 to continue 215D to the next stage of the pharmaceutical preparation process.

If the processing circuitry 130 (e.g. fluid analysis subsystem 135) instead determines that caking is present, processing circuitry 130 (e.g. agitation control unit 142) can change parameters of the shaking behavior of vial manipulator/agitator 110. For example, the vial can be agitated with greater amplitude, greater acceleration, and/or in a changed pattern of motion (e.g., along a bottom-to-top axis of the vial, in a figure-8 pattern, in a circular motion, in a randomized pattern, or in another shaking pattern).

By way of non-limiting example: if vial manipulator/agitator 110 shakes vial 115 in linear motion in the x and z planes at a particular angle, manipulator/agitator 110 can change 220D the angle of agitation to dislodge and dissolve the caked solid, and continue shaking. Optionally, if continued shaking does not resolve the caking, processing circuitry 130 (e.g. fluid analysis subsystem 135) can raise an alert indicating that the solid did not properly dissolve in the fluid.

It is noted that the teachings of the presently disclosed subject matter are not bound by the flow diagram illustrated in FIG. 2D. It is also noted that whilst the flow chart is described with reference to elements of the system of FIG. 1, this is by no means binding, and the operations can be performed by elements other than those described herein.

FIG. 2E illustrates a flow diagram of an additional example method of controlling dissolution of a solid into a fluid, as part of a process of pharmaceutical preparation in a robotic pharmaceutical preparation system, in accordance with some examples of the presently disclosed subject matter.

The method illustrated in FIG. 2E can be appropriate to—for example—preparation of a certain medical solutions that result from fully dissolving a powder substance into a fluid, in which dissolution of the solid continues after the halting of shaking.

By way of non-limiting example, cyclophosphamide is a drug used in chemotherapy. In some examples, cyclophosphamide may fail to dissolve completely and immediately. In this case, it is advised to allow the vial to stand for a certain amount of time.

Processing circuitry 130 (e.g. agitation control unit 142) can control vial manipulator/agitator 110 to shake 205E a vial 115 held by the vial manipulator/agitator 110 for an amount of time (for example: a time suitable for a particular solid to dissolve in the fluid).

After expiration of a particular time interval (for example: a time sufficient for dissolution of a particular solid into a particular fluid), processing circuitry 130 (e.g. agitation control unit 142) can then wait 210E for a certain duration to pass to allow “settling” of the solution. In some examples, the settling time is 0.

Processing circuitry 130 (e.g. fluid analysis subsystem 135) can next evaluate (for example, by machine learning classification, as described hereinabove) whether the fluid is currently transparent 215E (or: in some examples, whether the fluid clarity meets a clarity criterion).

If the processing circuitry 130 (e.g. fluid analysis subsystem 135) determines that the fluid in the vial 115 is indeed transparent, processing circuitry 130 (e.g. global control unit 145) can then control the vial manipulator/agitator 110 to continue 220E to the next stage of the pharmaceutical preparation process.

If the processing circuitry 130 (e.g. fluid analysis subsystem 135) instead determined that the fluid is not transparent (or, if appropriate, does not meet the clarity criterion), processing circuitry 130 (e.g. global control unit 145) can raise 225E an alert indicating that the solid did not properly dissolve in the fluid.

It is noted that in some examples, processing circuitry 130 (e.g. fluid analysis subsystem 135) can evaluate for transparency (or the clarity criterion) multiple times (e.g. with pauses between), before raising the alert indicating that the solid did not dissolve.

It is noted that the teachings of the presently disclosed subject matter are not bound by the flow diagram illustrated in FIG. 2E. It is also noted that whilst the flow chart is described with reference to elements of the system of FIG. 1, this is by no means binding, and the operations can be performed by elements other than those described herein.

FIG. 2F illustrates a flow diagram of an example method of detecting and reporting faults in a process of dissolution of a solid into a fluid, as part of a process of pharmaceutical preparation in a robotic pharmaceutical preparation system, according to some examples of the presently disclosed subject matter.

Processing circuitry 130 (e.g. agitation control unit 142) can control vial manipulator/agitator 110 to shake 205F a vial 115 held by the vial manipulator/agitator 110.

Processing circuitry 130 (e.g. fluid analysis subsystem 135) can evaluate 210F whether specific faults have occurred.

By way of non-limiting example, processing circuitry 130 (e.g. fluid analysis subsystem 135) can evaluate one or more of the following types of faults:
Mismatch between the fluid color and the expected fluid color (which can indicate that the type of solid is incorrect, or that the quantity of solid or fluid is incorrect). It is noted that the expected fluid color can be variable, and dependent on the type of solid and/or type of fluid that is in the vial.
Presence of foreign particles (e.g. particles which fell from a septum) are present in the fluid (which can indicate contamination of the solution, or damage to internal components of the vial). For example, FIG. 4B depicts an example image of a vial (captured from beneath the file) including foreign particles.
Mismatch between the fluid level and an expected fluid level (which can indicate leakage from the vial). In some examples, an imager can be placed beside vial 115 to monitor fluid volume. In some examples, a method as described, e.g., in relation to FIG. 7 (and other related figures) is used to evaluate fluid level.

It is noted that the expected fluid level can be variable, and dependent, e.g., on the quantity of fluid that was initially in the vial, on a quantity of fluid which was commanded and/or observed to be injected into the vial, and/or a quantity which has been adjusted to account for operations to withdraw fluid from the vial.

Processing circuitry 130 (e.g. fluid analysis subsystem 135) can evaluate whether one or more of these faults have occurred, for example, by machine learning classification, as described hereinabove.

If the processing circuitry 130 (e.g. fluid analysis subsystem 135) determines that a fault has in fact occurred, processing circuitry 130 (e.g. global control unit 145) can raise 215F an alert indicating that a fault occurred (and in some examples include the details of the fault).

It is noted that the teachings of the presently disclosed subject matter are not bound by the flow diagram illustrated in FIG. 2F. It is also noted that whilst the flow chart is described with reference to elements of the system of FIG. 1, this is by no means binding, and the operations can be performed by elements other than those described herein.

FIG. 3 illustrates a flow diagram of an example general method of monitoring and controlling a process of dissolution of a solid into a fluid, optionally as well as detecting and reporting faults, as part of a process of pharmaceutical preparation in a robotic pharmaceutical preparation system, according to some examples of the presently disclosed subject matter.

Processing circuitry 130 (e.g. agitation control unit 142) can control vial manipulator/agitator 110 to initiate 305 agitation of (for example) a vial 115 that is held, for example, by the vial manipulator/agitator 110.

Processing circuitry 130 (e.g. fluid analysis subsystem 135) can then receive 310 an image, captured by the camera, of the fluid in the vial 115.

It is noted that in some examples, processing circuitry 130 (e.g. agitation control unit 142) can halt shaking of vial 115 before the capture of the image, whereas in other examples shaking can continue during the capture of the image, as well as, in some examples, subsequent image processing.

Processing circuitry 130 (e.g. fluid analysis subsystem 135) can next classify 315 the received image to determine characteristics of the fluid/solid in vial 115. Optionally, characteristics are determined by measurement of a characteristic of image shape, intensity, dynamic characteristics (e.g., among two or more images, for example, difference magnitudes) or in another manner.

By way of non-limiting examples, processing circuitry 130 (e.g. fluid analysis subsystem 135) can determine the presence of one or more of the following types of characteristics of the fluid and/or solid:
Transparency or lack of transparency of the fluid/solid mixture.
Degree of clarity of the fluid/solid mixture, or whether the fluid/solid mixture meets a certain required clarity.
Whether there is caking on an internal surface of vial 115.
Mismatch between the fluid color and the expected fluid color (which can indicate that the type of solid is incorrect, or that the quantity of solid or fluid is incorrect). It is noted that the expected fluid color can be variable, and dependent on the type of solid and/or type of fluid that is in the vial.
Presence of foreign particles are present in the fluid (which can indicate contamination of the solution, or damage to internal components of the vial).
Mismatch between the fluid level and an expected fluid level (which can indicate leakage from the vial).

It is noted that the expected fluid level can be variable, and dependent on the quantity of fluid that was initially in the vial.

As described in detail above, with reference to FIG. 1, in some examples, processing circuitry 130 (e.g. fluid analysis subsystem 135) performs classification of the image using a trained machine learning model to determine the presence of one or more of the characteristics.

In some other examples, processing circuitry 130 (e.g. fluid analysis subsystem 135) uses other image processing methods to determine the presence of one or more of the characteristics.

Processing circuitry 130 (e.g. agitation control unit 142 or global control unit 145) can then perform 320 next steps according to the determined characteristics.

By way of non-limiting example, processing circuitry 130 (e.g. agitation control unit 142 or global control unit 145) can perform one or more of the following steps, in response to determined characteristics:
Halting the agitation by the agitator.
Modify operational parameters of agitator 110, such as, for example, changing an angle of shaking.
Moving vial 115 to a next stage of a preparation process (for example: controlling a robot arm to remove the vial from the vial holder).
Raising an alert.

FIGS. 2A-2F describe example methods of controlling dissolution of the solid into the liquid which involve performing specific next steps in response to determination of specific fluid characteristics.

It is noted that the teachings of the presently disclosed subject matter are not bound by the flow diagram illustrated in FIG. 3. It is also noted that whilst the flow chart is described with reference to elements of the system of FIG. 1, this is by no means binding, and the operations can be performed by elements other than those described herein.

Visual Inspection for Fluid Presence and/or Volume

### Image Assessment of Liquid Vial Contents

Reference is now made to FIG. 7, which is a flowchart schematically representing a method of image-based inspection of a vial for determining its contained fluid quantity, in accordance with some examples of the presently disclosed subject matter. Reference is also made to FIG. 8, which is a flowchart schematically representing a method of image-based inspection of a vial for determining the presence of fluid, in accordance with some examples of the presently disclosed subject matter. The two methods are described in parallel, with references to specific blocks as appropriate. Optionally they are both performed. Optionally, they are performed at the same time (e.g., using the same images of the vial). Optionally, these two methods are performed separately, or only one of them is performed.

### Vial Tilt Angles For Contents Imaging

At blocks 705 (FIG. 7) and/or 805 (FIG. 8), in some examples, inspection images of a vial are obtained and/or accessed. The inspection images show the vial with a tilt angle applied. The tilt angle tilts the vial away from a vertical orientation in which the bottom side of the vial is perpendicularly oriented to the direction of gravity acceleration. The inspected vial is expected to contain an amount of liquid contents, and computed image analysis of the inspection images is used to verify that the amount is within specifications. Optionally, in the case of FIG. 8, the inspected vial is expected not to contain liquid contents, in which case operations are inverted in reported results as appropriate.

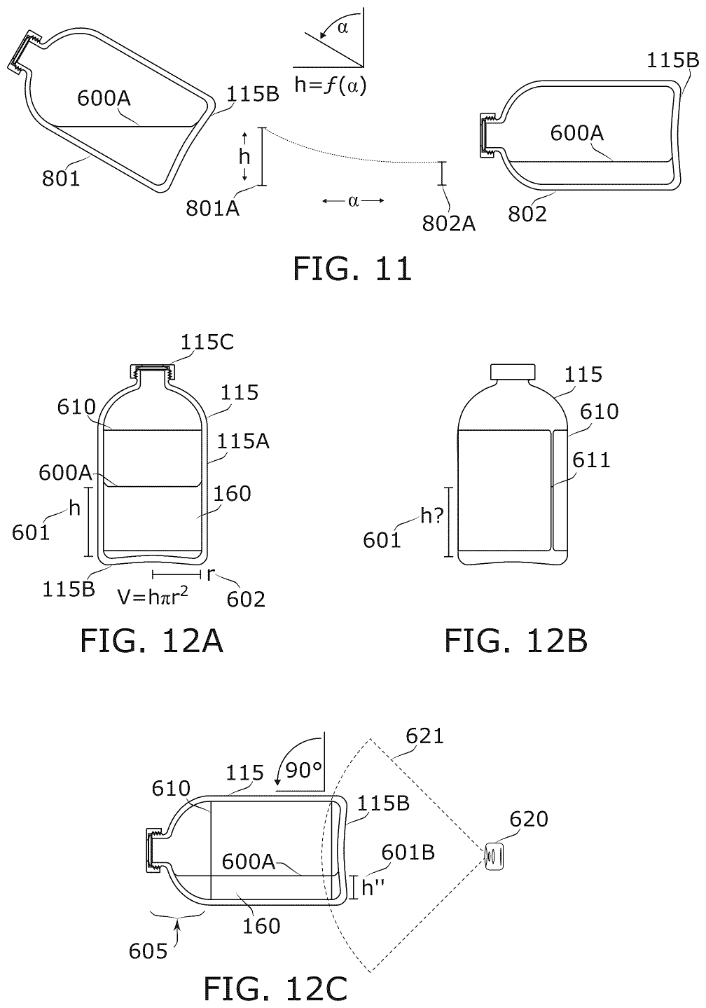

Brief reference is made to FIGS. 12A-12B, which schematically represent a side-view cross section (FIG. 12A) and side view (FIG. 12B) of a labeled fluid-containing vial 115, in accordance with some examples of the presently disclosed subject matter. Vial 115 is vertically upright, and not tilted. Although fluid 160 is present and forms an optically distinct boundary region 600A, the presence of label 610 leaves no gap or only a small gap 611 through which a side view of vial 115 could allow visualization of boundary region 600A. The boundary region is formed due to characteristics of the vial contents such as a difference in optical density between fluid and gas, and/or another characteristic, e.g., as described in the overview.

Even if present, gap 611 is potentially positioned unreliably, and/or even if located is too narrow for reliable automatic detection of boundary region 600A. However, it may be understood that if boundary region 600A were identified, the volume of fluid 160 could be determined, at least approximately, from knowledge of internal vial radius r 602, and boundary region height h 601 above the interior bottom of vial 115.

In some examples, a tilted vial 115 is imaged through the surface of vial bottom 115B, which is typically circular, and flat enough to allow resting the vial upright on a surface. Deviations from an ideal flatness of the bottom surface potentially affecting image quality include texturing (e.g., with ridges or raised dots around the rim), slight concavity, impressed or raised markings (e.g., lettering, numbering and/or a logo), and/or manufacturing defects. It is noted that despite these potential disadvantages for use in through-imaging of contents, the bottom of the vial generally remains clear of labeling such as label 610.

Accordingly, rather than appearing vertically as shown in FIGS. 12A-12B, the vial is tilted away from vertical by a tilt angle α.

Brief reference is also made to FIG. 12C, which schematically represents a side-view cross section of a fluid-containing vial 115 with an 90° tilt angle α, in accordance with some examples of the presently disclosed subject matter. This has the effect of reducing height h 601 of FIGS. 12A-12B to height h″ 601B, as fluid 160 spreads into a larger containing area. Label 610 still obscures much of the side view (though it is removed in the cross-sectional view).

Typically, tilt angle(s) of the vial in the image are chosen so that boundary region 600A is positioned where it crosses through (or is expected to cross through) a viewable area in inspection images of the vial. For example, it crosses through vial bottom 115B from the vantage of imager 620 and within imager field of view 621 in the example shown. Accordingly, in some examples, a measurement region of the vial surface forms a bottom or top of a cylinder or prism, but is not itself along an ascending wall of this shape.

In some examples, the measurement region of the vial surface (beyond which the boundary region is imaged) does not form part of a main right-cylindrical or right-prism shaped portion of a vial. For example, boundary region 600A can be seen in part through vial top 605, in a region which (in an upright position of vial 115) would be above the more regularly cylindrical portion of vial 115.

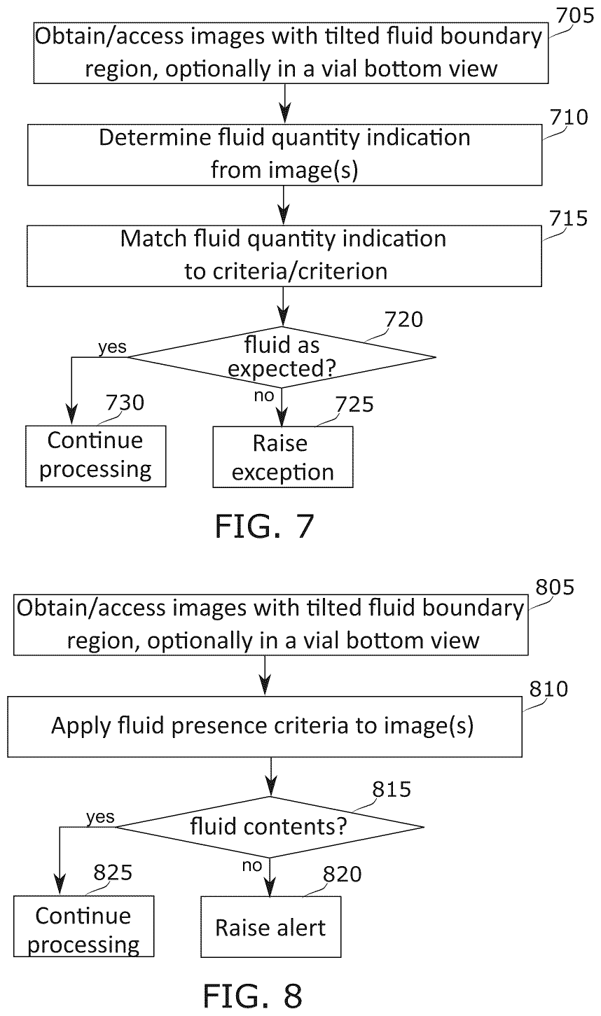

Brief reference is made to FIG. 9A, which reproduces a photograph of a fluid-containing vial 115 held by a gripper 110 with a tilt angle of about a 90°, in accordance with some examples of the presently disclosed subject matter. The presence (considering FIG. 8) and/or level (considering FIG. 7) of fluid contents 160A is to be determined automatically according to the presence and/or position of boundary region 600A, made visible by a difference in refractive index between fluid contents 160A and gas filling the rest of vial 115.

Brief reference is made to FIG. 9B, which reproduces a photograph of a solid-containing vial 115 held by a gripper 110 with a tilt angle of about a 90°, in accordance with some examples of the presently disclosed subject matter. The absence of fluid contents is to be determined automatically according to the absence of a boundary region, and/or according to image characteristics indicative of the presence of solid 160B.

Brief reference is made to FIG. 9C, which reproduces a photograph of a fluid-containing vial 115 held by a gripper 110 with a tilt angle of about a 90°, in accordance with some examples of the presently disclosed subject matter. The presence (considering FIG. 8) and/or level (considering FIG. 7) of fluid contents 160A is to be determined automatically according to the presence and/or position of boundary region 600A, made visible by a difference in color (i.e., optical density at at least one wavelength) between fluid contents 160A and gas filling the rest of vial 115.

Returning to blocks 705, 805: in examples using bottom-view images, the tilt angle is optionally any angle which deviates the vial from vertical enough to place the boundary region of interest in anticipated contact with (visible through) the vial bottom. This condition is preferably selected to apply when the vial is liquid-filled as specified during preparation of a pharmaceutical preparation; e.g., filled in at least 20% of its volume, at least 30%, at least 50% (mostly filled), or another relative (or absolute) filling quantity by volume.

The tilt angle may be, for example, about 90° (i.e., the vial is oriented on its side as shown in FIG. 12C and/or FIGS. 9A-9C).

Additionally or alternatively, another tilt angle is used. In some examples, for example, tilt angles of from 75°-90° are used, In some examples, the tilt angle away from vertical is at least 45°, at least 60°, or at least 75°. In some examples, at least partially inverting tilt angles are used; that is, tilt angles larger than 90°. For example, tilt angles of 90°-105° are used.

Optionally, images of the vial are obtained for a plurality of tilt angles, e.g., to help ensure that at least one tilt angle shows the boundary region in a location suitable for measurement by image processing. Tilt angle is optionally selected according to an expected volume of liquid in the vial and/or according to procedural presets.

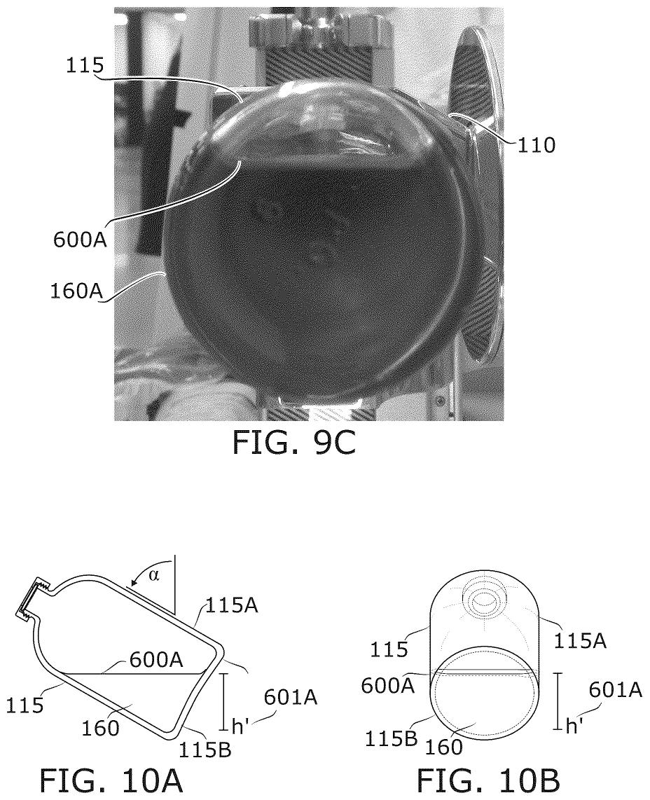

Brief reference is made to FIG. 11, which schematically represents side-view cross sections of a fluid-containing vial 115 with a changing tilt angle α, in accordance with some examples of the presently disclosed subject matter. In position 801, the tilt angle is about 60°; in position 802, the tilt angle is about 90°. The graph between the two illustrated positions represents variation of a height h from height 801A in position 801, to height 802A in position 802. Optionally, imaging occurs at any one, two or more positions in this range. Each of these positions should show a boundary region 600A which intersections vial bottom 115B.

Returning to blocks 705, 805: using tilt angle(s) which place the boundary region within the viewed area of the vial provides a potential advantage; e.g., insofar as a large portion of the vial wall may be obscured by labeling and so undependable and/or unavailable for use in verifying fluid contents presence and/or volume.

In some examples, a tilt angle actually applied to a vial (i.e., as used in assessing presence/quantity of fluid contents) is known from data separate from images of the boundary layer. For example, the tilt angle is set by operations of the pharmaceutical preparation system, and known on the basis of encoder measurements, gravimetric sensing, or another source of data. Optionally, tilt angle is determined by pre-arrangement: e.g., a processing algorithm is designed with the assumption that images it receives always correspond to the vial held at a certain tilt angle, or the images are otherwise ensured to correspond with a predetermined tilt angle.

Additionally or alternatively, in some examples, tilt angle is inferred and/or confirmed from the image itself, e.g., based on the apparent eccentricity of a round vial bottom due to image foreshortening. As a potential advantage of relying on inference of tilt angle from the imaged shape of the vial: this may conveniently decouple operations of vial manipulating from imaged observation of the vial, e.g., to reduce risks of data skew, and/or to provide independent verification that mechanical aspects of operations are within intended parameters.

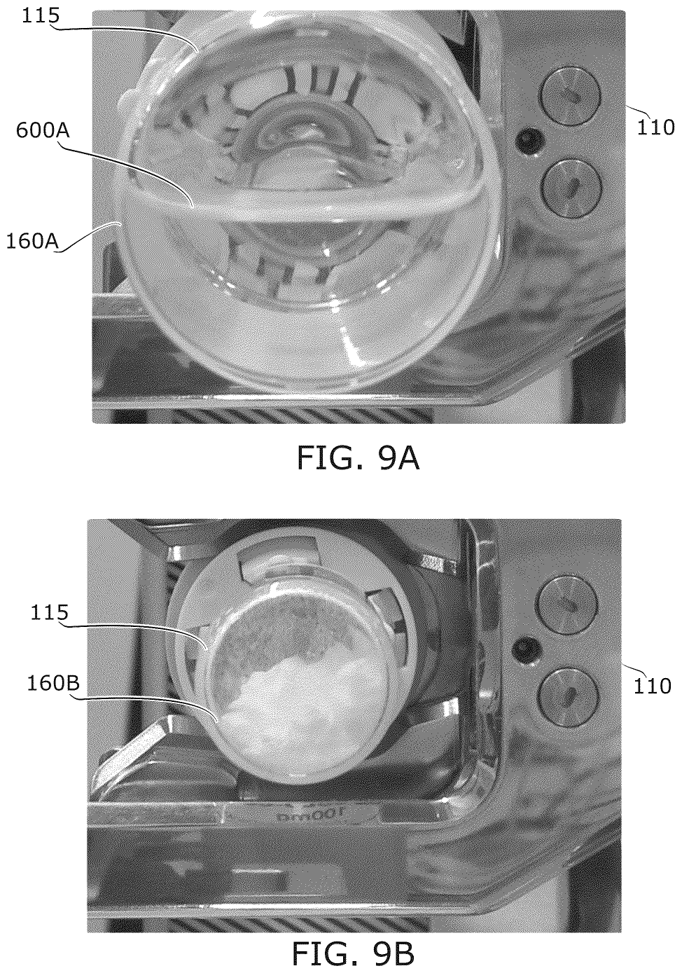

Brief reference is made to FIGS. 10A-10B, which schematically represent a side-view cross section (FIG. 10A) and a bottom view (FIG. 10B) of a fluid-containing vial 115 with an oblique tilt angle α, in accordance with some examples of the presently disclosed subject matter. In the example shown, α is about 60°. Fluid 160 fills vial 115 to the level h′ 601A. It may be noted that the oblique angle leads to a foreshortened view of vial bottom 115B in FIG. 10B, selectively along the vertical axis. This eccentricity, along with the assumption that vial bottom 115B is actually circular, allows the tilt angle to be inferred from measurements of the vertical and horizontal axes of vial bottom 115B. Depending on field of view settings used for imaging, there may also be an effect on imaged geometry due to the receding of vial bottom 115B in lower parts of the image. This is also optionally accounted for.

Returning to the operations of blocks 705, 805: in some examples, the tilted vial is imaged with its contents in a positional equilibrium: that is, the vial is not in motion relative to the imager, is not accelerating (except insofar as it is acted upon by gravity), and more particularly, the boundary region of interest remains at a steady position during image exposure. This has potential advantages for accuracy and reproducibility of measurements.

However, positional equilibrium is not necessarily required. For example, with the vial itself in a steady, non-accelerated position after a recent stop, a certain amount of residual sloshing of fluid contents (and, in particular, movement of the boundary region on the bottom view of the vial) may be accommodated by measuring enough images to determine characteristics of this movement. A center-point of the range, for example, may be determined; and/or a settling state toward which motions of the vial contents trend may be determined. Conversely, absence of such a moving boundary is optionally used as evidence of a lack of fluid altogether.

In another example, the vial may be rotated dynamically through a range of angles α (e.g., rotated around an interior point of the vial), with images being obtained at different exposure periods during this rotation. The rate of rotation is optionally low enough that non-equilibrium aspects of conditions can be neglected in calculations.

Alternatively (returning to blocks 705, 805), dynamic effects may be compensated for in whole or in part during calculations. Potential advantages of imaging during dynamic motion of the vial include a more rapid measurement process, and/or integration of the measurement process into other operations performed by the pharmaceutical preparation system, in which vial positions potentially suitable for use in measurements may be incidentally generated, and/or generated without as much impact on procedure time as a separately implemented volume measurement phase might require.

In some examples, the vial is accelerated during image exposure. For example, it is accelerated linearly, and/or moves through an arc centered on a point outside of the vial (e.g., a circular motion, as in a centrifuge). This can lead to displacement of the boundary region away from perpendicular to the direction of the force of gravity acting alone, potentially even with the vial itself remaining in a vertical orientation. The camera used for imaging is optionally synchronized to motions of the vial in any suitable fashion, e.g., panning to follow motion of the vial, or fixed on a manipulator which also moves the vial.

In some examples (e.g., as mentioned in relation to FIG. 12C), images providing a view onto the top of a vial are optionally used to verify that fluid presence and/or fluid quantity requirements are met. Optionally, this is in place of bottom-viewing images. There are potential advantages for bottom-side views in particular, insofar as the shape of the bottom of a vial is typically relatively flat and regular in shape (round), compared to the typically curving (e.g., ellipsoidal) surface of a vial's top, which may also comprise the interruption which comprises the vial's neck and cap. Particularly at lower tilt angles, more of the fluid contents may be held in a cylindrically shaped region of the vial, which potentially lowers the number of assumptions needed to account for the shape of the vial interior in volume estimates. Also, vial tops may be obscured while held for manipulation, although bottom-side and/or side-wall gripping of vials is not excluded from implementation.

However, a top-side view, if available, may provide information suitable for determining fluid presence, e.g., once the boundary region rises above the level of an obscuring label. Quantitative volume estimation may be obtained in cases where the vial shape is and/or can be adequately modeled. Likewise, side views of the vial are optionally used in estimating fluid contents (optionally exclusively), so long as the boundary region (e.g., the region where the fluid meniscus contacts the vial wall) has been displaced by tilting into a location where it can be viewed. Moreover, any of the views may optionally be used in combination. Combinations of imaged views potentially provide information which assists in achieving more accurate determinations of fluid quantity, for example, as described in relation to block 710.

Optionally, in the case of block 805 and the method of FIG. 8, the vial is not tilted, but rather viewed from an angle expected to bring any potential solid contents of the vial up against an unobstructed region of the vial wall. For example, the vial is held vertically, and viewed from the bottom surface. Potential advantages of tilting the vial anyway include that this moves the powder within the vial (an indication of the presence of solid material), and/or that this also allows confirming the presence of the boundary region.

### Determination of Fluid Quantity Indications

At blocks 710 (FIG. 7) and/or 810 (FIG. 8), in some examples, a fluid quantity indication is determined from the one or more images obtained and/or accessed at blocks 705, 805.

Herein, the term “fluid quantity indication” refers to an indication of how much fluid is in the vial, either absolutely (e.g., in a volumetric unit proportional to milliliters), or with respect to an otherwise specified fluid quantity requirement (e.g., a reference volume). At block 715 (FIG. 7), in some examples, the fluid quantity indication is matched to requirements.

The two blocks of FIG. 7 are introduced together, because the definition of a fluid quantity indication is related to implementation of operation requirement matching. In particular, two classes of implementation may be characterized as “relative volume” implementations, and “absolute volume” implementations.

### Relative Volume Implementations

In some examples of relative volume implementations, the fluid quantity indication comprises the position of a boundary region with respect to a viewable surface region of the vial as such. For example, it may be predetermined that for a certain tilt angle and model of vial (i.e., a certain interior vial geometry), a targeted fluid contents quantity results in a particular location of the boundary region relative to vial surface landmarks (e.g., a circular outer perimeter of the vial bottom). Using, e.g., image segmentation techniques, the vial bottom and/or other vial surface landmarks may be identified. In some examples, the boundary region position is identified with respect to another reference; for example, a coordinate axis established by mechanical arrangements of the pharmaceutical preparation system itself (e.g., a vertical axis with known relative positions for a gripper holding the vial and a camera imaging the vial).

The boundary region itself may be identified, e.g., as a linear (narrow rectangular) region extending transversely (or otherwise as expected) across the vial bottom, e.g., characterized by a sharp contrast gradient (for a line), by two such contrast gradients (for a bright or dark line), or otherwise using edge detector or other image processing algorithms, optionally selected and implemented in accordance with the particular conditions of lighting and imaging used. Optionally, the boundary region detector is selected to be robust against ordinary levels of viewing distortion imposed by relatively small irregularities of the vial wall portion through which it is viewed.

Where the image of the boundary region is not generally linear in shape (e.g., when it is expected that the boundary region will be imaged where it contacts a curving top or side of the vial), image processing algorithms optionally model the boundary region as an appropriately parameterized curve. For example, the curve may be parameterized as appropriate for an intersection of an oblique plane with a cylindrical- and/or ellipsoidal-shaped wall portion, projected onto the imaging plane of the camera. In some examples, images themselves are geometrically transformed to normalize (e.g., make more linearly shaped) the shape of imaged boundary regions, before application of detection algorithms.

The targeted location for the boundary region is optionally defined, for example, as a line or curve which the boundary region contains (or surpasses), an area region which the boundary region intersects, or in another fashion.

Even without necessarily accessing data indicating what the targeted fluid contents quantity itself actually is (e.g., in milliliters), an image processing algorithm can determine that a geometrically specified criterion based on this quantity is met.

Accordingly, it may convert the fluid quantity indication into a pass/fail indication, as part of the operations of block 715. Optionally, additional categories are added to such determinations (e.g., “too empty” or “too full”). Optionally, the amount of deviation from an expectation value is provided as an indication; e.g., as a deviation in position. Optionally, such deviation is reported statistically, e.g., with respect to multiples of a standard deviation or other statistical measure. Optionally, deviation in position is otherwise calibrated; e.g., in percent, and/or in an absolute volumetric unit such as milliliters.

In some examples, the calibration is calculated roughly to indicate overfilling or underfilling, e.g., deviation from a targeted position of the boundary region in millimeters is converted by a linear scale to a difference in milliliters, even though this may be increasingly inaccurate as the distance of boundary region deviation increases. It may be understood that the type and number of corrections applied to a relative volume implementation may be increased according to this approach until it becomes in effect an instance of the class of absolute volume implementations described with additional details below.

The acceptability of purely relative and/or roughly calibrated assessments of fluid quantity may be different, depending on the type of pharmaceutical preparation being mixed, regulatory requirements, reagent value, and/or another parameter. Accordingly, it is a potential advantage to be able to adjust calibration procedures, and/or the amount of prior knowledge used, according to such requirements.

Optionally, the reference against which fluid quantity indications are evaluated is determined as part of the normal operation of the pharmaceutical preparation system, and this is one of the potential advantages of a relative volume implementation. For example, the system may run for a period of time in which several vials are handled, with fluid quantity indications being accumulated from each. Assuming errors during this period are rare, absent, or otherwise negligible and/or excludable, these results can be used (e.g., statistically) for one or both of evaluating the fluid contents quantities in vials imaged during the period of time, and setting a standard against which fluid quantity indications in other vials can be evaluated. Particularly during future vial handling, alerts and/or mitigating actions can be taken immediately upon sensing a relative discrepancy in fluid contents, even when there is optionally no direct representation of a targeted and/or presently vial-contained volume of fluid in milliliters.

### Absolute Volume Implementations

Turning now to the class of absolute volume implementations of blocks 710, 715: the amount of liquid contents targeted is optionally specified as a volume requirement proportional to milliliters (e.g., a particular volume, a particular volume with a range of acceptable error, and/or a range of volumes). In the descriptions which follow, calibrations between image pixels and sizes in space are assumed to be known and/or calculable from system dimensions, fiducial marks, and/or other suitable constraints.

Determining of the fluid quantity indication may begin as described for relative volume implementations; that is, by finding the position in an image of a boundary region with respect to a viewable surface region. To convert this to a milliliter-proportional volume, the operations of block 710 optionally make use of any suitable combination of modeled and measured parameters which describe (at least approximately) an internal geometry of the vial. These parameters may approximate the actual internal vial geometry more or less accurately, according to requirements.

A simple case is applicable, e.g., when the fluid volume is relatively low compared to a height of a generally right-cylindrical portion of the vial. The vial's interior volume may be simply modeled as a right cylinder with circular cross-section extending indefinitely upward from its bottom.

The circular cross-section is optionally determined from an image of the vial's bottom, e.g., assuming that the diameter to use is about equal to the maximum horizontal width of the vial (as imaged), minus two times a “reasonable” vial wall thickness (e.g., 1.5 mm, or another value, e.g., a value also estimated from the image). Optionally, any or all vial geometry model values are provided separately from the images, e.g., according to a known model of vial being used.

For relatively low tilt angles (that is, as long as the “upper” reach of the boundary region does not extend past the cylindrical region of the vial), the quantity of fluid contained can be calculated as the volume of the model cylinder lying below a plane extending through and parallel to the boundary region.

When the low-volume/low-tilt condition does not apply, the vial model can be enhanced, e.g., by assuming for the vial a maximum height, a curved (e.g., ellipsoidal) upper portion, and/or a cylindrical neck, as appropriate. Optionally, the parameters for any of these are measured by imaging, although directly measuring the vial wall thickness is potentially error prone due to optical distortions. Even in this case, corrections for wall thickness are optionally determined based on empirical measurements and/or a physical model incorporating reasonable assumptions about the index of refraction of the vial wall material. Optionally, the parameters for any of these are provided separately from images, e.g., as parameters describing a known model of vial. The model may be extended further as required, e.g., to include corrections for meniscus shape and/or container irregularities such as concavity of the vial bottom. With complete enough modelling, performed in this or another fashion, any tilt angle and imaged position of the boundary region can be correlated to a particular fluid quantity, expressed in a milliliter-proportional unit. Optionally, elaboration of the model is confined to parameters which have a meaningful effect within a particular range of tilt angles.

It is noted, furthermore, that where there is a free (unknown) parameter in the model (e.g., wall thickness), a potential source of information to help assign it a value is available by measuring how the position of the boundary region changes as a function of tilt angle. For example, given outer dimensions of the vial (which are optionally directly determined from imaging), an unknown constant vial wall thickness, and the image-measured dependency of the boundary region position on tilt angle (e.g., for at least two tilt angles), it may be possible to fix wall thickness to a value (or a constrained range of values) for which calculated volume remains the same as a function of changing tilt angle.

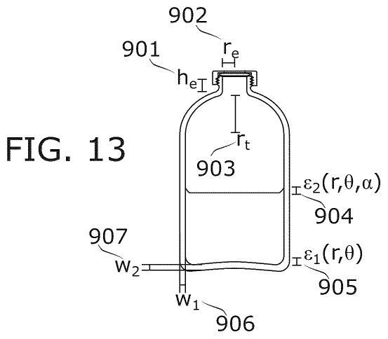

Brief reference is made to FIG. 13, which is a schematic diagram of vial geometry parameters, according to some examples of the present disclosure. The vial 115 inner volume geometry parameter of bottom radius r 602 is described in relation to FIG. 12A. In some examples, one or more additional geometrical parameters of a vial is described and/or accounted for in calculating a fluid contents volume. For example, in some examples, vial wall thickness w˜1 907 is subtracted from an outer vial radius to arrive at an estimate of bottom radius r 602. Optionally, an inner height of a cylindrical portion of vial 115 is calculated by subtracting an estimated, known, or image-measured vial bottom thickness w˜2 906 from an image-measured (outer) overall height of the cylindrical portion. In some examples, parameters for other portions of the vial 115 internal geometry are estimated, e.g., a height radius r˜t 903 of a top portion of vial 115. In some examples, volume calculation takes into account a correction function ε˜2 (r, θ, α) 904 for distortions due to the fluid meniscus shape of the boundary region, where θ is a parameter for angle around the vial wall parallel to a plane where the boundary region contacts the vial wall, and a is the tilt angle. In some examples, a correction takes into account deviations from a planar shape for a bottom interior surface of vial 115 ε˜2 (r,θ) 906, where θ is a parameter for angle around the vial wall.

### Responses to Fluid Quantity Indications

At block 720, in some examples, and according to the results of matching fluid quantity indication to requirements at block 715, a determination is made as to whether the fluid quantity indication is as expected (required). If so, then at block 730, processing continues, using the now verified contents of the vial. Otherwise, at block 725, an exception is raised.

The exception of block 725 is optionally functionally connected with one or more consequences related to functioning of the pharmaceutical preparation system. For example, the exception triggers any one or more of:
A user alert, which signals to a device operator that their attention is needed (e.g., by visual, haptic, auditory, or other signaling; optionally using hardware of the system itself, and/or remotely connected hardware to which signals are communicated wirelessly).
An internal fault, which causes operation of the system to halt operations (or at least bypass suspected faulty functionality) until the fault condition is cleared.
Self checks, e.g., to determine whether the unexpected fluid quantity indication can be traced to a particular condition.
Adjustments, e.g., to correct the volume in the vial by injecting more fluid or removing fluid, to place the vial in a discard or special reserve area, and/or to access a replacement vial and re-attempt the failed portion of the pharmaceutical mixing procedure.

It is noted that system self-checks and/or adjustments are optionally operations which the system can perform for itself, but are sufficiently intensive of system resources that they are not ordinarily performed, until an exception such as that of block 725 is raised. This gives the operations of the method of FIG. 7 a status as a gating method for other operations, allowing system self-recovery, and/or potentially lowering direct monitoring requirements on some other system component. For example, as it reaches the end of its rated capacity, a saline reservoir bag may be in a partially indeterminate state with respect to how much more saline can be drawn from it. Rather than exchange the bag prematurely, it may be used until a condition of insufficient fluid is positively identified by the operations of FIG. 7, at which time the system may then proceed through defined operations to rectify (and re-verify, as appropriate) both the empty saline reservoir condition and the under-filled vial condition.

### General

As used herein with reference to quantity or value, the term “about” means “within ±10% of”.

The terms “comprises”, “comprising”, “includes”, “including”, “having” and their conjugates mean: “including but not limited to”.

The term “consisting of” means: “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

The words “example” and “exemplary” are used herein to mean “serving as an example, instance or illustration”. Any embodiment described as an “example” or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the present disclosure may include a plurality of “optional” features except insofar as such features conflict.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

Throughout this application, embodiments may be presented with reference to a range format. It should be understood that the description in range format is merely for convenience and brevity and should not be construed as an inflexible limitation on the scope of descriptions of the present disclosure. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Although descriptions of the present disclosure are provided in conjunction with specific embodiments, it is evident that many alternatives, modifications and variations will be apparent to those skilled in the art. Accordingly, it is intended to embrace all such alternatives, modifications and variations that fall within the spirit and broad scope of the appended claims.

It is appreciated that certain features which are, for clarity, described in the present disclosure in the context of separate embodiments, may also be provided in combination in a single embodiment. Conversely, various features, which are, for brevity, described in the context of a single embodiment, may also be provided separately or in any suitable subcombination or as suitable in any other described embodiment of the present disclosure. Certain features described in the context of various embodiments are not to be considered essential features of those embodiments, unless the embodiment is inoperative without those elements.

It is the intent of the applicant(s) that all publications, patents and patent applications referred to in this specification are to be incorporated in their entirety by reference into the specification, to the same extent as if each individual publication, patent or patent application was specifically and individually noted when referenced that it is to be incorporated herein by reference. In addition, citation or identification of any reference in this application shall not be construed as an admission that such reference is available as prior art to the present disclosure. To the extent that section headings are used, they should not be construed as necessarily limiting. In addition, any priority document(s) of this application is/are hereby incorporated herein by reference in its/their entirety.

What is claimed is:

1. A method of controlling dissolution of a solute into a solvent in a vial, the vial being held by a vial holder in a pharmaceutical preparation device, the method comprising:
agitating the vial holder by an agitator operably connected to the vial holder, thereby shaking the solute and the solvent in the vial being held by the vial holder;
accessing, by processing circuitry, at least one image of vial contents captured after the agitation was initiated;
by image processing with the processing circuitry, assessing a characteristic of vial contents;
comparing the assessed characteristic to a targeted characteristic of the vial contents; and
adjusting, by the processing circuitry, agitation by the agitator, in accordance with a result of the comparing.

2. The method of claim 1, wherein the adjusting comprises halting agitation.

3. The method of claim 1, wherein the adjusting comprises restarting agitation.

4. The method of claim 1, wherein the adjusting comprises modifying at least one parameter of agitation motion.

5. The method of claim 1, wherein the solute is a solid.

6. The method of claim 1, wherein the solvent is a fluid.

7. The method of claim 1, wherein the assessed characteristic assesses dissolution of the solute into the solvent, the targeted characteristic of the vial contents comprises a dissolution appearance criterion, and the adjusting comprises halting or extending a period of operation of the agitator.

8. The method of claim 7, wherein the adjusting comprises halting operation of the agitator while the targeted dissolution appearance criterion remains unsatisfied; and raising an alert.

9. The method of claim 7, wherein the adjusting comprises extending operation of the agitator while the targeted dissolution appearance criterion remains unsatisfied.

10. The method of claim 7, wherein the dissolution appearance criterion comprises a measure of at least one of:
transparency of the solvent,
color of the solvent, and
clarity of the solvent.

11. The method of claim 10, wherein the dissolution appearance criterion comprises the measure of color of the solvent, selected in accordance with a type of the solute.

12. The method of claim 1, wherein the assessed characteristic assesses caking of the solute, the targeted characteristic of the solvent in the vial comprises a caking appearance criterion, and the adjusting comprises modifying a parameter governing a movement pattern of the agitator.

13. The method of claim 12, wherein the movement pattern is adjusted in at least one of:
an amplitude,
an acceleration,
a rotation of the vial, and
a geometry of a path along which the vial is moved.

14. The method of claim 1, wherein the assessed characteristic assesses presence of foreign particles in the solvent, the targeted characteristic of the vial contents comprises a foreign particle presence criterion, and the adjusting comprises halting agitation; and also in accordance with the result of the comparing, the processing circuitry raises an alert.

15. The method of claim 1, wherein the assessed characteristic assesses presence of foreign particles in the solvent, the targeted characteristic of the vial contents comprises a foreign particle presence criterion, and the adjusting comprises halting agitation; and also in accordance with the result of the comparing, the processing circuitry raises an alert.

16. The method of claim 1, wherein the assessed characteristic assesses a volume of the vial contents, the targeted characteristic of the solvent in the vial comprises an expected amount of the vial contents, and the adjusting comprises halting agitation; and also in accordance with the result of the comparing, the processing circuitry raises an alert.

17. The method of claim 1, wherein at least one of the assessing the characteristic and the comparing comprises classifying the at least one image in accordance with a pre-trained machine learning model.

18. The method of claim 1, wherein the adjusting comprises adjusting agitation of an at least second vial, according to the result of the comparing.

19. The method of claim 18, wherein the adjusting is according to a plurality of said results of a respective plurality of said comparings.

20. The method of claim 1, wherein the at least one image of vial contents is imaged from a position below the vial.

21. A system for controlling dissolution of a solute into a solvent in a vial, the vial being held by a vial holder in a pharmaceutical preparation device, the system comprising processing circuitry configured to:
control an agitator operably connected to the vial holder, thereby shaking the solute and the solvent in the vial being held by the vial holder;
access at least one image of vial contents captured after the agitation was initiated;
assess a characteristic of the vial contents;
compare the assessed characteristic to a targeted characteristic of the solvent in the vial; and
adjust agitation of the agitator in accordance with a result of the comparing.

22. The system of claim 21, wherein the assessed characteristic assesses dissolution of the solute into the solvent, the targeted characteristic of the solvent in the vial comprises a dissolution appearance criterion, and the processing circuitry adjusts agitation by halting or extending a period of operation of the agitator.

23. The system of claim 21, wherein the assessed characteristic assesses caking of the solute, the targeted characteristic of the solvent in the vial comprises a caking appearance criterion, and the processing circuitry adjusts agitation by modifying a parameter governing a movement pattern of the agitator.

24. The system of claim 21, wherein the assessed characteristic assesses presence of foreign particles in the solvent, the targeted characteristic of the solvent in the vial comprises a foreign particle presence criterion, and the processing circuitry adjusts agitation by halting agitation; and also in accordance with the result of the comparing, the processing circuitry raises an alert.

25. The system of claim 21, wherein the assessed characteristic assesses presence of foreign particles in the solvent, the targeted characteristic of the solvent in the vial comprises a foreign particle presence criterion, and the processing circuitry adjusts agitation by halting agitation; and also in accordance with the result of the comparing, the processing circuitry raises an alert.

26. The system of claim 21, wherein the assessed characteristic assesses a volume of solvent in the vial, the targeted characteristic of the solvent in the vial comprises an expected amount of solvent in the vial, and the processing circuitry adjusts agitation by halting agitation; and also in accordance with the result of the comparing, the processing circuitry raises an alert.
